(19) United States
(12) Patent Application Publication
(10) Pub. No.: US 2015/0339690 A1
(43) Pub. Date: Nov. 26, 2015

(54) Qualitative Price Management Method

(71) Applicant: Otis Stevens, Austin, TX (US)

(72) Inventor: Otis Stevens, Austin, TX (US)

(21) Appl. No.: 14/282,973

(22) Filed: May 20, 2014

(51) Int. Cl. G06Q 30/02; G06Q 10/06

(52) U.S. Cl. CPC G06Q 30/0206; G06Q 10/06311; G06Q 50/30

(57) ABSTRACT

Disclosed herein is a method of qualitative price management for businesses, which schedule services that use crews, the method comprising: providing a software application; gathering base pricing data for a requested service; displaying a matrix of qualitatively-adjustable global discount factors; qualitatively adjusting the global discount factors; using a pricing algorithm to determine a base daily discount rate for an individual day using the gathered base pricing data and the qualitatively-adjusted global discount factors; storing the calculated base daily discount rates in a database; displaying the calculated base daily discount rates in a monthly calendar format along with a qualitatively-adjustable discount override for each day; if further daily discount adjustment is desired, qualitatively-adjusting the total discount for a given day by using the qualitatively-adjustable discount override in the displayed monthly calendar; and color-coding the total daily discount depending on the size of the discount.

### CROSS-REFERENCE TO RELATED APPLICATIONS

This application claims benefit of U.S. Provisional Patent Application No. 61/825,891 which was filed on May 21, 2013, and which is incorporated herein in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention is in the technical field of price management methods. More particularly, the preferred embodiments of the present invention relate generally to qualitative price management methods. More particularly, the preferred embodiments of the present invention relate generally to methods for qualitative price management for companies that schedule services and manage work crews. More particularly, the preferred embodiments of the present invention relate generally to qualitative price management methods, which allow for the qualitative adjustment of prices based on the day of the week for any given week, the day of the month for any given month, and/or the month of the year. More particularly, the preferred embodiments of the present invention relate generally to qualitative price management methods, which display color-coded daily discounts in a calendar format and allow for the qualitative adjustment of a discount price for a specific day. More particularly, the preferred embodiments of the present invention relate generally to qualitative price management methods for moving companies. Additionally, the present invention relates generally to methods of qualitative price management, which display qualitatively adjusted prices in an online marketplace.

2. Description of the Related Art

The broad concept of using dynamic pricing methods is known; however, these methods usually rely on comprehensive data sets to drive price adjustments and require businesses to have highly structured data sets available and already in place in order to start using these methods. These dynamic pricing methods do not allow for qualitative adjustment of prices based on the knowledge, experience or intuition of a small business operator, and initiating these systems is beyond the capabilities of most small service businesses.

It is also known to use methods to display pricing information in useful ways; however, these displays of pricing information do not allow for qualitative adjustment of prices within the displays themselves.

It is also known to use an algorithm to determine pricing; however, these pricing algorithms are based on large conglomerations of historic data, which may not be available to a small company. Additionally, these pricing algorithms do not display prices in a format that allows for easy qualitative adjustment of the prices within the display based on the instincts of a business operator and in the absence of large data sets.

It is also known to use methods to determine markdown pricing; however, these methods are data driven and do not account for a small business owner's familiarity with their own business or allow for markdown pricing to be qualitatively adjusted by a small business owner based on the owner's unconscious insights or hunches.

It is also known to adjust prices based on manual input; however, this manual input usually involves the straightforward input of a custom price. There are no tools available in the prior art that display discount prices in a calendar format and allow for the qualitative adjustment of daily discount prices along a limited scale that is defined by the intuition of a business operator.

It is also known to use digital sliders to make adjustments in software applications; however, the use of sliders is confined to the adjustment of colors along a spectrum or shades within a scale of varying tones, or qualities such as brightness or contrast of an image, and are not used to qualitatively adjust discount prices.

It is also known to use a software algorithm to determine prices for moving companies; however, these moving company software algorithms are data intensive and are intended for large moving companies, which are unlikely to rely on the intuition and/or instincts of a business operator.

General definitions for terms utilized in the pertinent art are set forth below.

Web browser is a complex software program, resident in a host device, that is capable of loading and displaying text and images and exhibiting behaviors as encoded in HTML (HyperText Markup Language) from the Internet, and also from the client computer's memory. Major browsers include MICROSOFT INTERNET EXPLORER, CHROME, NETSCAPE, APPLE SAFARI, MOZILLA FIREFOX, and OPERA.

Web Server is a computer able to simultaneously manage many Internet information-exchange processes at the same time. Normally, server computers are more powerful than client computers, and are administratively and/or geographically centralized. An interactive-form information-collection process generally is controlled from a server computer, to which the sponsor of the process has access.

Application is a software program for a host device, usually for performing a specific function or a range of specific functions.

### SUMMARY OF THE INVENTION

Many service businesses that cater to consumers have fluctuations in demand throughout the year. Services that are dependent on in consumer purchasing decisions may be affected by seasonal variations such as tax season, whether school is out, holidays, etc. As a result of these fluctuations, service businesses can experience problems with maintaining staff during the slow season or having enough personnel during the busy season. This problem is often exasperated for businesses that rely on work crews to perform their services. Many businesses will alter their pricing based on the season but do not have the ability to communicate pricing adjustments in real time to the user of their services or to sales representatives in their organization. Additionally, many of the service businesses may experience periodic fluctuations in demand, which are specific to their particular company, especially small businesses or owner-operated businesses. Without a tool to manage price changes, sales representatives are expected to decide on price adjustments based on their limited personal knowledge of the seasonal fluctuations, which is not as developed as the instincts and intuition of the business owner/operator, and these sales representatives are not always in the best position to make these decisions. In many cases, sales representatives will deliver a price for services to the customer during a phone conversation and do not have the time or information available to make a proper decision regarding price adjustments or discounts; they merely collect the necessary information to deliver a quote and do their best to consider other factors in arriving at a discounted price as quickly as they can. As a result, different sales representatives will determine different discount pricing with varying degrees of success. Erratic discount prices can easily result in the loss of consumer confidence in a business, translating to fewer sales and lower profits. Because service businesses must rely on their sales representatives to make accurate and repeatable pricing decisions based on many different factors, a higher caliber of salesperson may be required, thereby increasing wages and the expense for training.

To address periodic fluctuations in demand for services and efficiently optimize staff usage and management, businesses can offer services at lower rates during slow times in order to encourage consumers to utilize services during off peak periods. Under this arrangement, a business benefits by being able to keep its staff occupied when work is usually lacking, and consumers benefit from well-managed discount scheduling by paying lower prices during periods in which a business would ordinarily experience low volume booking. Further, consumers who would normally be unable to afford a business' services and would otherwise perform those services themselves are able to become new customers for the business by taking advantage of strategic pricing and utilizing off-peak scheduling.

Service businesses that do not have tools to effectively manage dynamic pricing experience challenges in providing online pricing over the Internet. Without the ability to make real time qualitative adjustments to pricing, many businesses are hesitant to offer their pricing online because doing so can lock in the price rate for offered services and prevent the ability to provide lower rates during slower times. Potential online customers who only have the ability to take advantage of discounted pricing during off-peak periods can be driven away if only the highest prices are available online. Service businesses also do not want consumers to schedule jobs on their busiest days at a discounted rate.

Small businesses often have specific factors, which are unique to the particular company and which determine the availability and willingness to maximize resources on any given day. These businesses require a tool, which would not simply rely on an algorithm that applies to any random business, but instead allows for easy qualitative adjustment of pricing based on the needs and instincts of the small business operator. There are many different scenarios in which an individual business owner/operator or manager would make a different pricing decision as compared to other businesses. For example, a small business owner may prefer to have a less work on Thursdays than on other days of the week simply based on the recreational schedule of the business owner. As another example, a business may schedule a staff meeting on a particular day and desire the ability to increase prices on that day to better assure the availability of its staff members to attend the staff meeting and limit the number of employees who are working in the field on the day of the meeting. If staff meetings do not occur regularly and occur on different days each month, it would be desirable to have the ability to easily make changes to daily discount pricing based on changes in staff meeting scheduling. Similarly, if staffing is limited because of a holiday, a small business would benefit by being able to easily adjust discount prices to discourage over booking on that holiday.

In a scenario in which several businesses compete for consumers in an online marketplace or clearinghouse, the ability of each business to make qualitative adjustments to discount pricing would provide advantages over other pricing optimization software because such a marketplace would have a wider range of pricing between the businesses, and it would allow consumers to identify which business has the most availability and the lowest costs over a range of dates. Additionally, an online marketplace with the ability of participating businesses to make qualitative adjustments to discount pricing in real time and on a whim allows discount pricing to become more competitive, and potential runs on discount pricing could result in extreme savings for consumers. Further, a system that associates qualitative discount adjustment to the month, day, and/or day of the week, permits a business owner/operator or manager to constantly maintain competitive discount offers on the online marketplace and prevents the business from neglecting the task of controlling dynamic pricing.

The broad embodiments of the present invention relate generally to a method of qualitative price management for businesses, which schedule services that use crews, the method comprising: providing a software application; gathering base pricing data for a requested service; displaying a matrix of qualitatively-adjustable global discount factors; qualitatively adjusting the global discount factors; using a pricing algorithm to determine a base daily discount rate for an individual day using the gathered base pricing data and the qualitatively-adjusted global discount factors; storing the calculated base daily discount rates in a database; displaying the calculated base daily discount rates in a monthly calendar format along with a qualitatively-adjustable discount override for each day; if further daily discount adjustment is desired, qualitatively-adjusting the total discount for a given day by using the qualitatively-adjustable discount override in the displayed monthly calendar; and color-coding the total daily discount depending on the size of the discount. More particularly, the preferred embodiments of the present invention relate generally to a method of qualitative price management for businesses, which schedule services that use crews, the method comprising: providing a web application that resides on a web server and is accessible by a computer through a web browser; gathering base pricing data for a requested service; displaying a matrix of sliders for qualitatively adjusting discount factors, including a maximum discount slider, day-of-the-week discount sliders, month-of-the-year discount sliders, and day-of-the-month discount sliders; qualitatively adjusting the discount factors using the matrix of sliders; using a pricing algorithm, which resides on the web server, to determine a base daily discount rate for an individual day using the gathered base pricing data and the qualitatively-adjusted discount factors; storing the calculated base daily discount rates in a database; displaying the calculated base daily discount rates for each day in a monthly calendar format along with a slider for qualitatively adjusting the discount for each day; if further discount adjustment is desired, qualitatively adjusting the total discount for a given day by using the daily sliders in the displayed monthly calendar; and color-coding the total daily discount depending on the size of the discount. The qualitative price management method of the present invention may be used to allow onsite sales representatives to provide price estimates that may be qualitatively adjusted by the business owner/operator, to allow sales representatives to provide price estimates over the phone that may be qualitatively adjusted by the business owner/operator, to provide businesses with the ability to offer online price estimates that may be qualitatively adjusted by the business owner/operator, and to allow competing businesses to provide price estimates in an online marketplace that may be qualitatively adjusted by the business owner/operator.

In the most preferred embodiments, the present invention relates to a method for establishing discount prices for moving services that allows moving companies to qualitatively adjust prices by using sliders displayed in an easy-to-use graphic user interface (GUI) with a color-coded calendar format. The qualitative price management method of the present invention comprises providing a web application that resides on a web server and is accessible by a computer through a web browser; gathering base pricing data for requested moving services, including months of the year, days of the week, days of the month, gross sales for any given day, gross sales for a given day plus the day before and the day after, and gross sales for a given day plus two days before and two days after, items to be moved, distance of the move, numbers of stairs, and/or like information; displaying a matrix of sliders for qualitatively adjusting discount factors, including a maximum discount slider, day-of-the-week discount sliders, month-of-the-year discount sliders, and day-of-the-month discount sliders; qualitatively adjusting discount factors using the matrix of sliders; using a pricing algorithm, which resides on the web server, to determine a base daily discount rate for an individual day using the gathered base pricing data and the qualitatively-adjusted discount factors; storing the calculated base daily discount rates in a database; displaying useful information for each day in a monthly calendar format, including the total bookings for a day, the base daily discount rate calculated by the pricing algorithm, the amount of qualitative adjustment for each day, whether a day is booked or not, the total discount, and a slider for qualitatively adjusting the discount for each day; if further discount adjustment is desired, qualitatively adjusting the total discount for a given day by using the daily sliders in the displayed monthly calendar; and color-coding the total discount to red, yellow, or green, depending on the size of the discount, with red being the lowest discount and green being the largest discount. In sum, the qualitative price management method of the present invention allows moving companies to generated rules-based quotes for moving services using historic supply and demand data and allows moving companies to qualitatively adjust daily discount offers using sliders displayed in a color-coded monthly calendar format. The qualitative price management method of the most preferred embodiment of the present invention may be used to allow onsite sales representatives to provide price estimates for moving services that may be qualitatively adjusted by the owner/operator of the moving company, to allow sales representatives to provide price estimates for moving services over the phone that may be qualitatively adjusted by the owner/operator of the moving company, to provide moving companies with the ability to offer online price estimates for moving services that may be qualitatively adjusted by the owners/operators of the moving companies, and to allow competing moving companies to provide price estimates for moving services in an online marketplace that may be qualitatively adjusted by the owners/operators of the moving companies; and the system combines these variations within a unified software application platform.

### BRIEF DESCRIPTION OF THE DRAWING

Illustrative and preferred embodiments of the present invention are shown in the accompanying drawings in which:

FIG. 1 is a flowchart of the process flow of the present invention;

FIG. 2 is a flowchart of the process flow of the discount weights user interface of the present invention of FIG. 1;

FIG. 3 is a flowchart of the process flow of the discount override adjustment user interface of the present invention of FIG. 1;

FIG. 4 is a flowchart of the process flow of the update discounts process of the present invention of FIG. 1;

FIG. 5 is a flowchart of the process flow of the show discounts user interface of the present invention of FIG. 1;

FIG. 6 is a flowchart of the process flow of the web quote user interface of the present invention of FIG. 1;

FIG. 7 is a flowchart of the process flow of the marketplace user interface of the present invention of FIG. 1;

FIG. 8 is a screen view of the dashboard of the present invention of FIG. 1;

FIG. 9 is a screen view of the discount weights user interface of the present invention of FIG. 1;

FIG. 10 is a screen view of the discount override adjustment user interface of the present invention of FIG. 1;

FIG. 11 is a screen view of the quote user interface of the present invention of FIG. 1;

FIG. 12 is a screen view of the web quote user interface of the present invention of FIG. 1;

FIG. 13 is a screen view of the web quote user interface of the present invention of FIG. 1;

FIG. 14 is a screen view of the web quote user interface of the present invention of FIG. 1;

FIG. 15 is a screen view of the web quote user interface of the present invention of FIG. 1;

FIG. 16 is a screen view of the web quote user interface of the present invention of FIG. 1;

FIG. 17 is a screen view of the web quote user interface of the present invention of FIG. 1;

FIG. 18 is a screen view of the web quote user interface of the present invention of FIG. 1;

FIG. 19 is a screen view of the web quote user interface of the present invention of FIG. 1;

FIG. 20 is a screen view of the marketplace user interface of the present invention of FIG. 1;

FIG. 21 is a screen view of the marketplace user interface of the present invention of FIG. 1;

FIG. 22 is a screen view of the web quote user interface of the present invention of FIG. 1;

FIG. 23 is a screen view of the web quote user interface of the present invention of FIG. 1;

FIG. 24 is a screen view of the web quote user interface of the present invention of FIG. 1;

FIG. 25 is a screen view of the crew layout user interface of the present invention of FIG. 1;

FIG. 26 shows formulas of the present invention of FIG. 1;

FIG. 27 shows formulas of the present invention of FIG. 1; and

FIG. 28 shows formulas of the present invention of FIG. 1.

### DETAILED DESCRIPTION OF THE PREFERRED EMBODIMENTS

For the purpose of illustration, the present invention is shown in the most preferred embodiment of a qualitative price management method for moving companies, the method comprising: providing a web application that resides on a web server and is accessible by a computer through a web browser; gathering base pricing data for requested moving services, including months of the year, days of the week, days of the month, gross sales for any given day, gross sales for a given day plus the day before and the day after, and gross sales for a given day plus two days before and two days after, items to be moved, distance of the move, numbers of stairs, and/or like information; displaying a matrix of sliders for qualitatively adjusting discount factors, including a maximum discount slider, day-of-the-week discount sliders, month-of-the-year discount sliders, and day-of-the-month discount sliders; qualitatively adjusting discount factors using the matrix of sliders; using a pricing algorithm, which resides on the web server, to determine a base daily discount rate for an individual day using the gathered base pricing data and the qualitatively-adjusted discount factors; storing the calculated base daily discount rates in a database; displaying useful information for each day in a monthly calendar format, including the total bookings for a day, the base daily discount rate calculated by the pricing algorithm, the amount of qualitative adjustment for each day, whether a day is booked or not, the total discount, and a slider for qualitatively adjusting the discount for each day; if further discount adjustment is desired, qualitatively adjusting the total discount for a given day by using the daily sliders in the displayed monthly calendar; and color-coding the total discount to red, yellow, or green, depending on the size of the discount, with red being the lowest discount and green being the largest discount. Additionally, within a unified software application platform, the most preferred embodiment of the present invention is shown allowing onsite sales representatives to provide price estimates for moving services that may be qualitatively adjusted by the owner/operator of the moving company, allowing sales representatives to provide price estimates for moving services over the phone that may be qualitatively adjusted by the owner/operator of the moving company, providing moving companies with the ability to offer online price estimates for moving services that may be qualitatively adjusted by the owners/operators of the moving companies, and allowing competing moving companies to provide price estimates for moving services in an online marketplace that may be qualitatively adjusted by the owners/operators of the moving companies. These embodiments are not intended to limit the scope of the present invention.

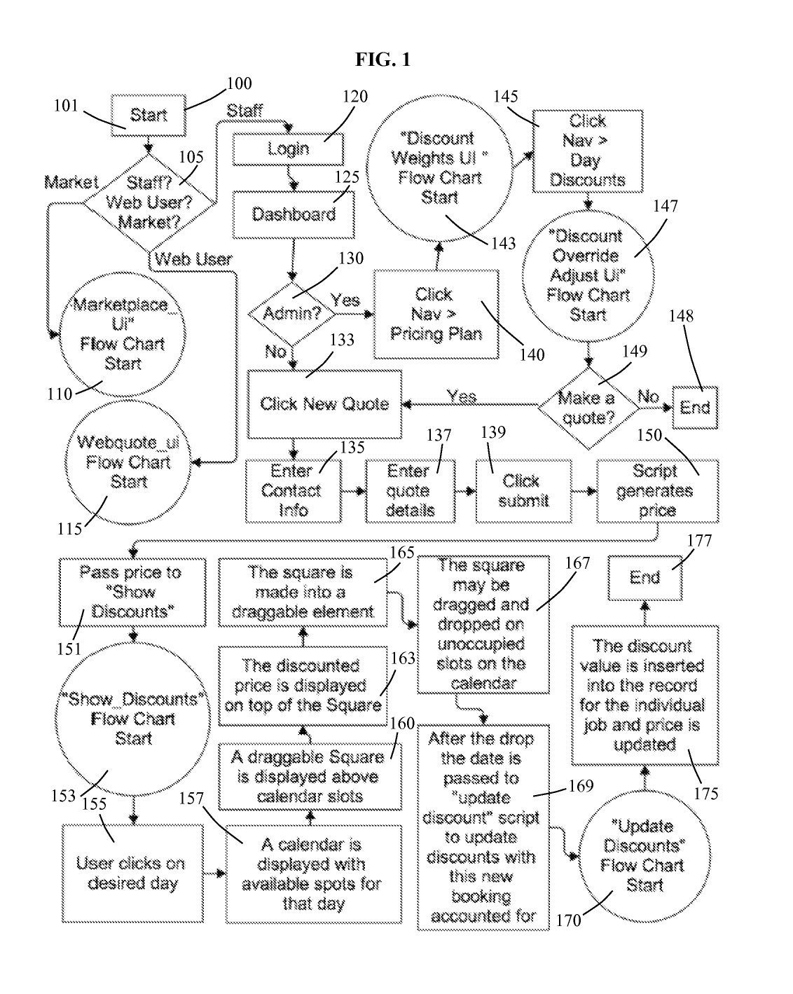

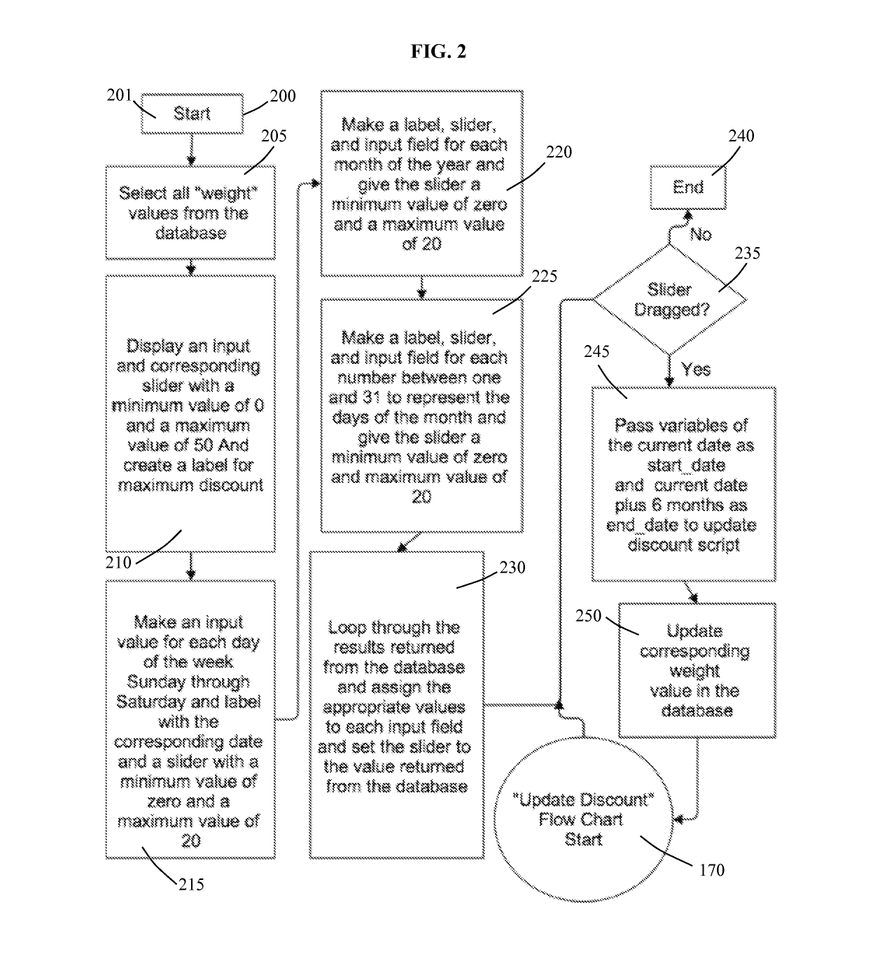

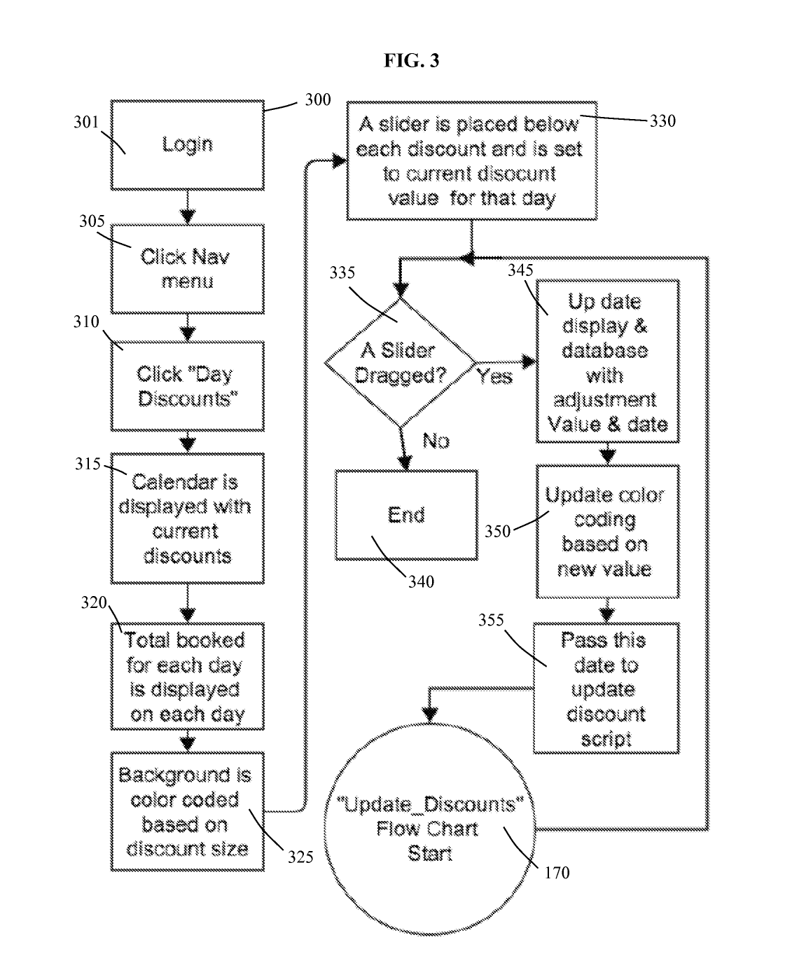

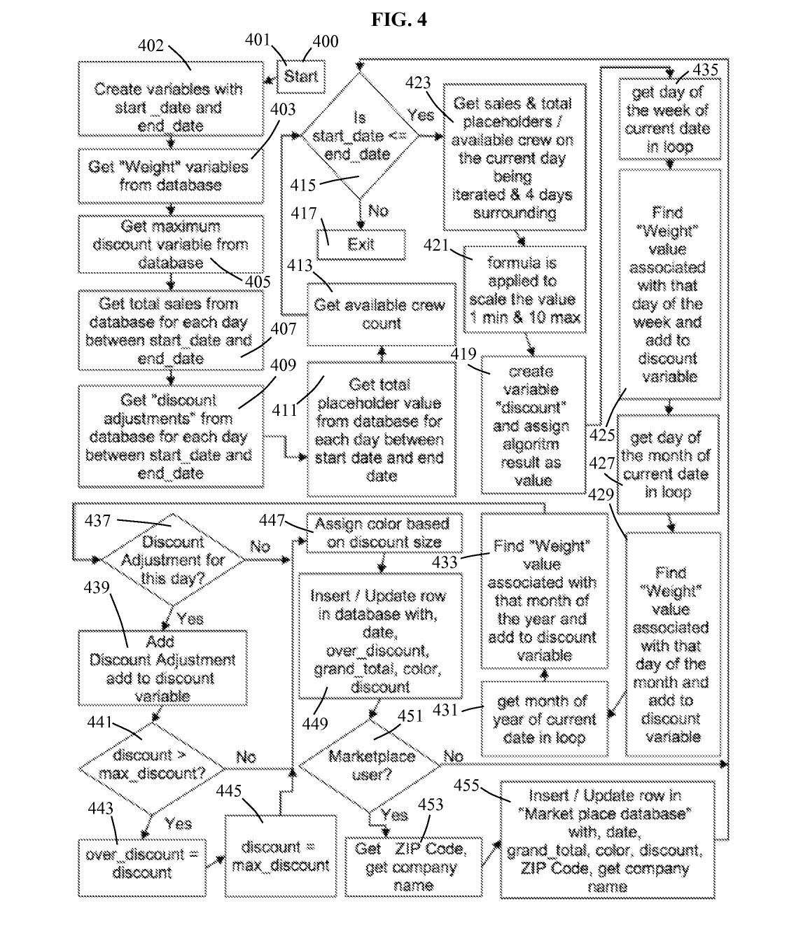

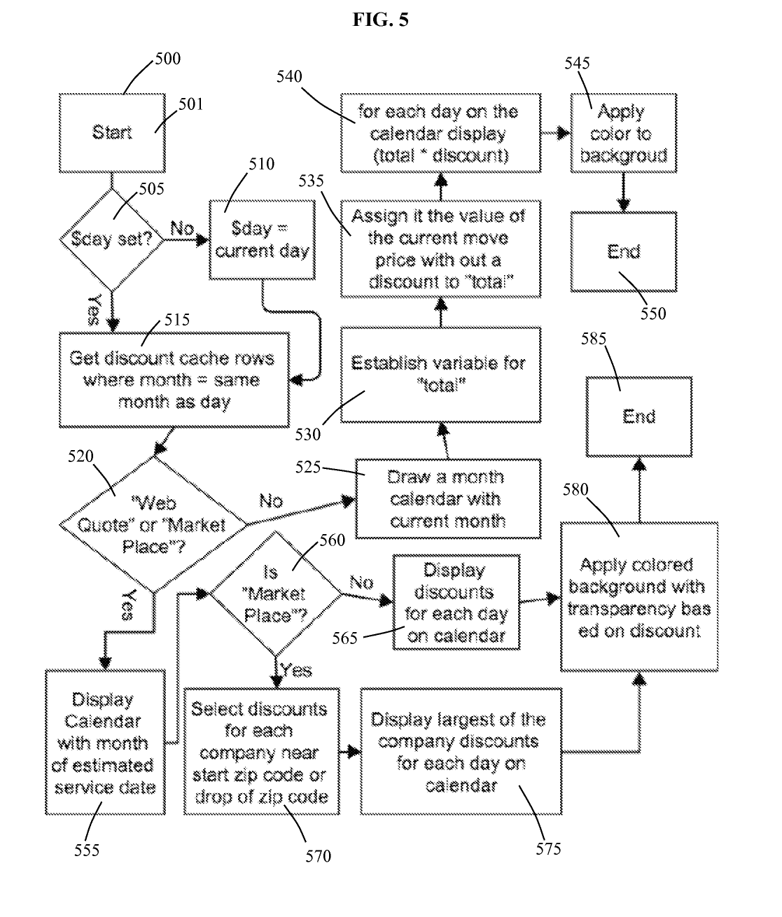

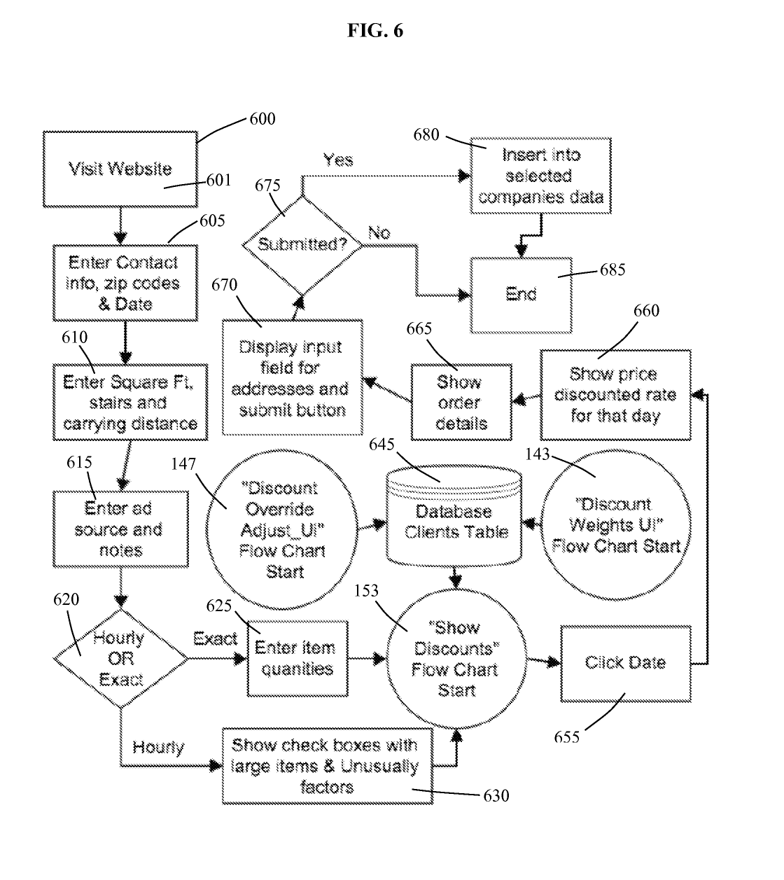

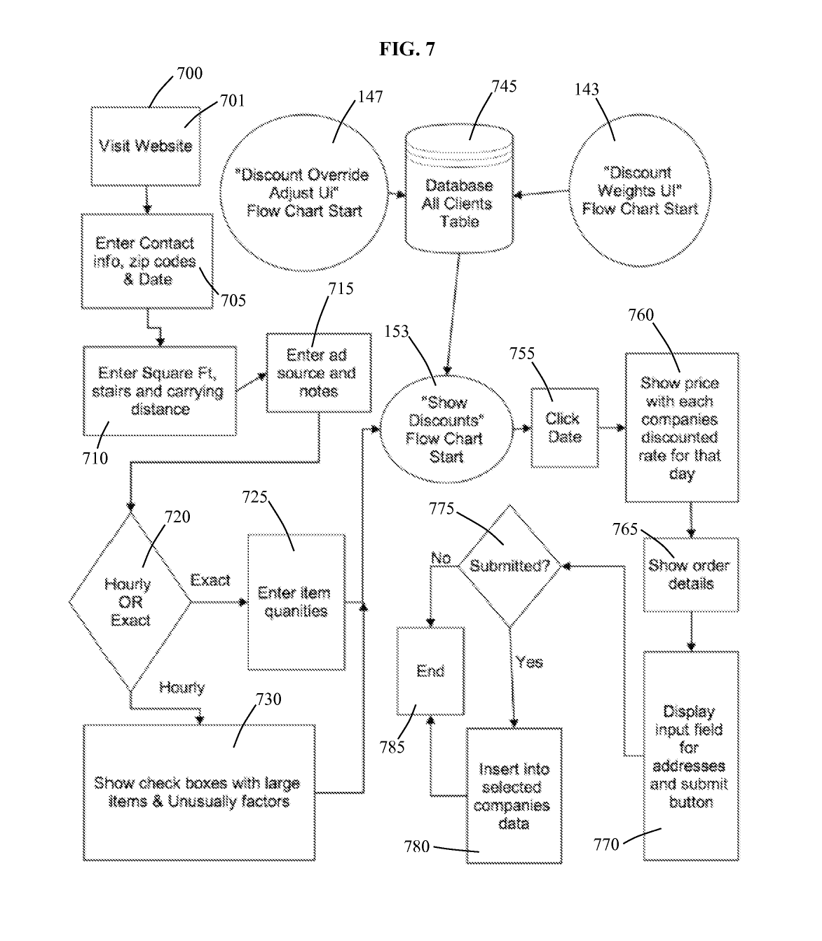

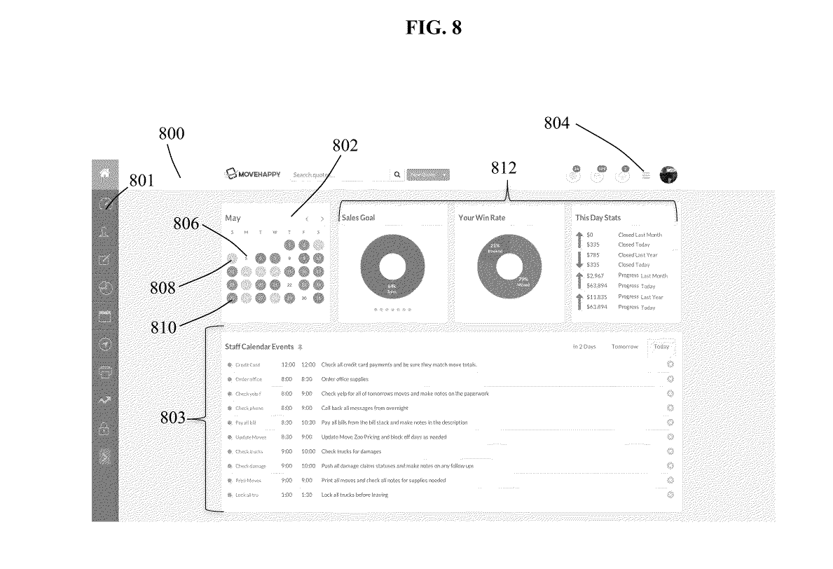

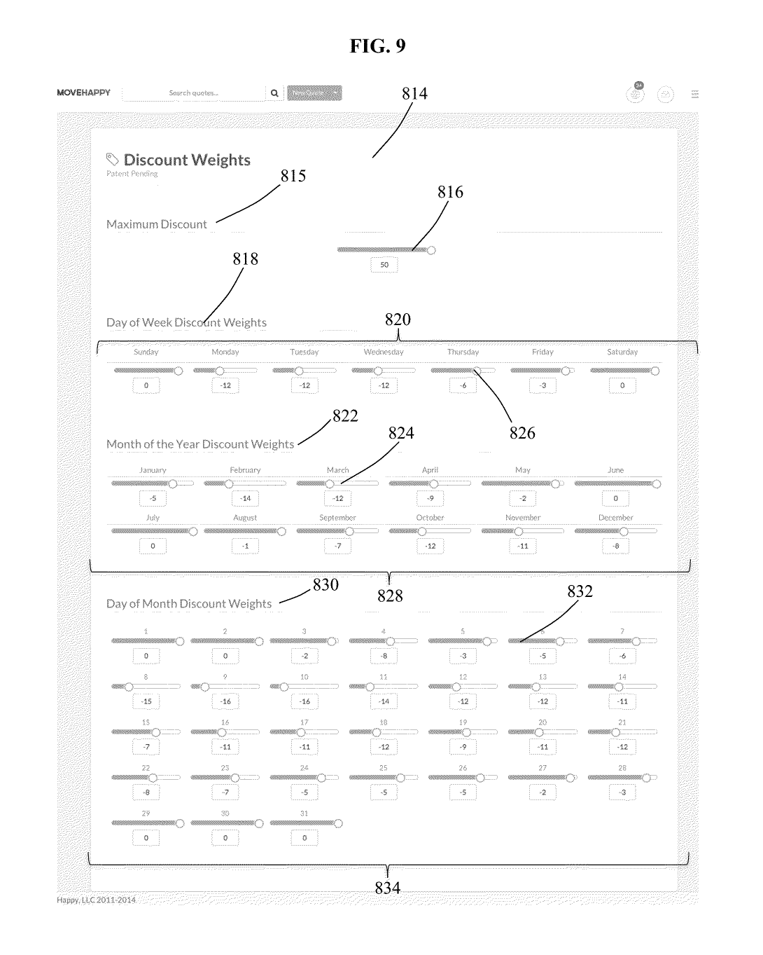

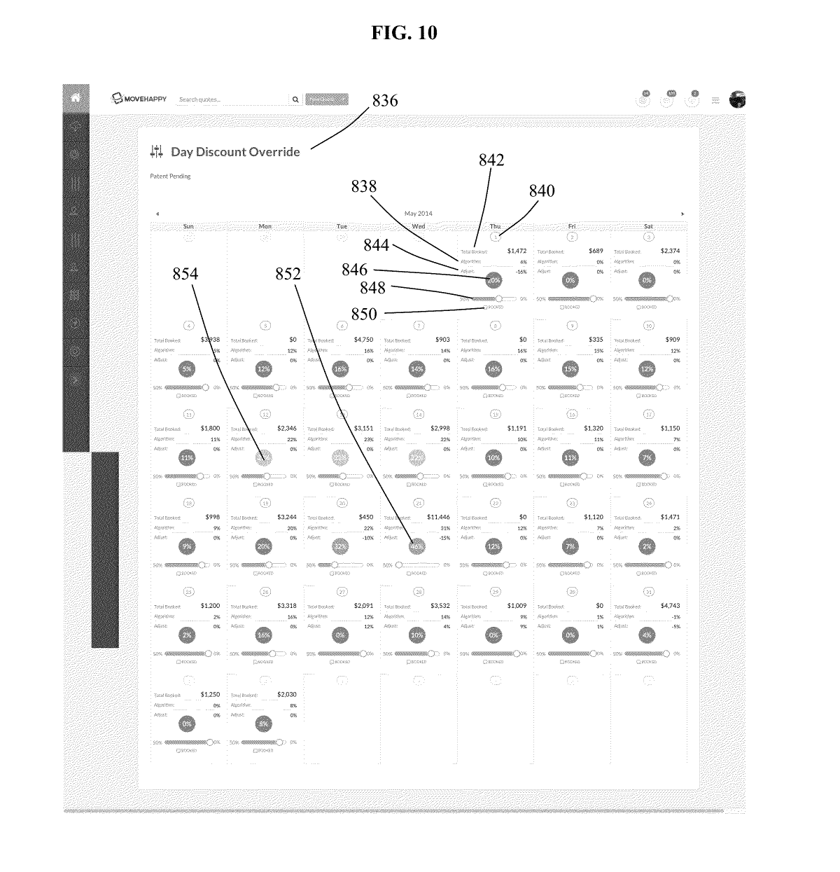

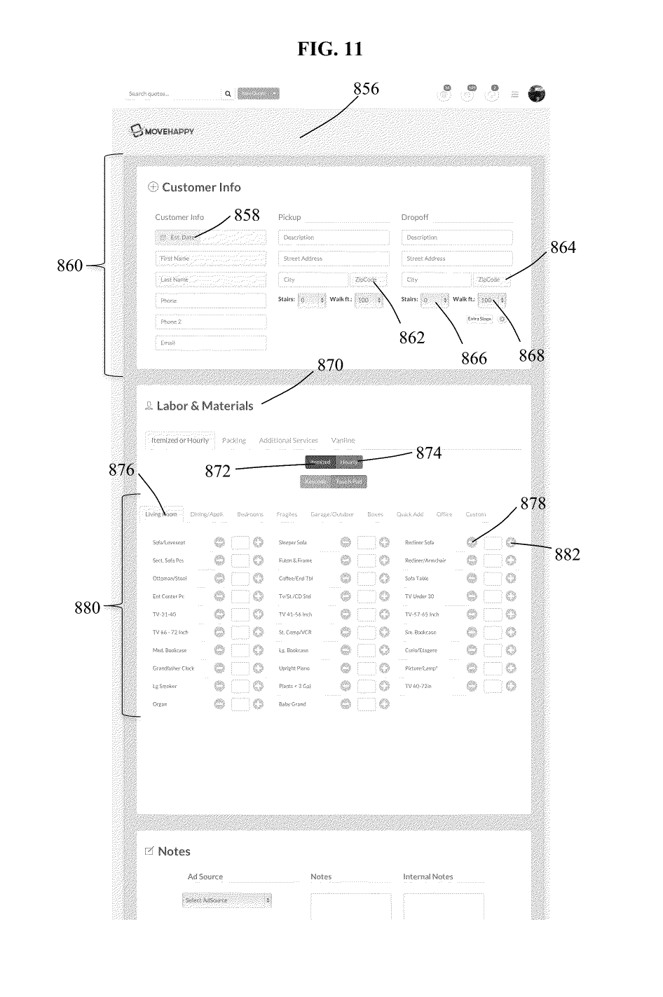

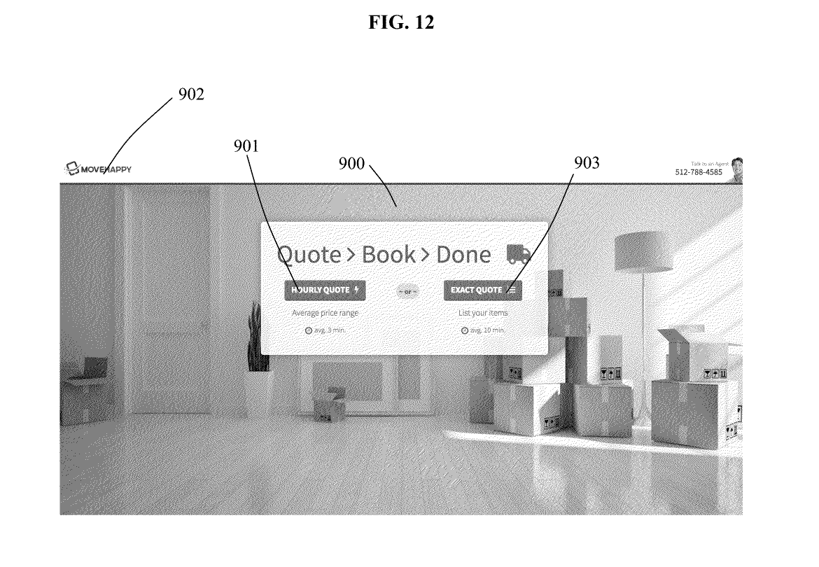

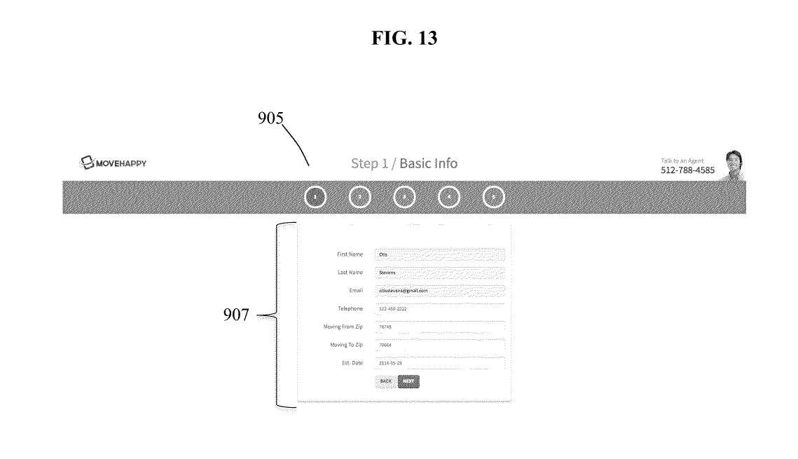

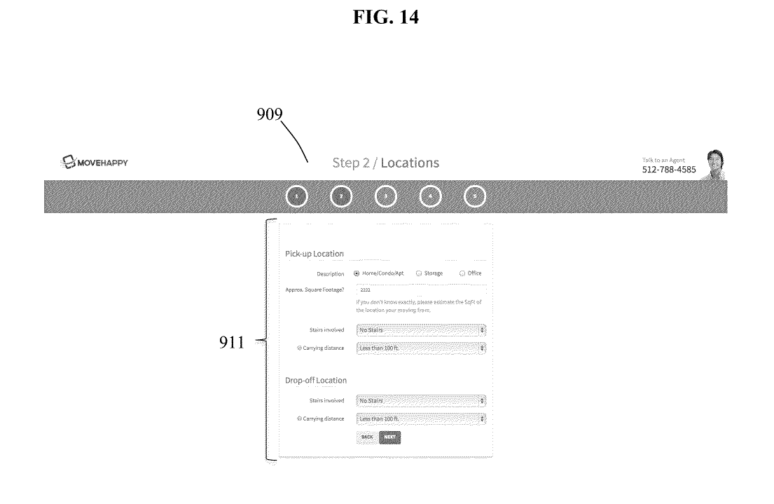

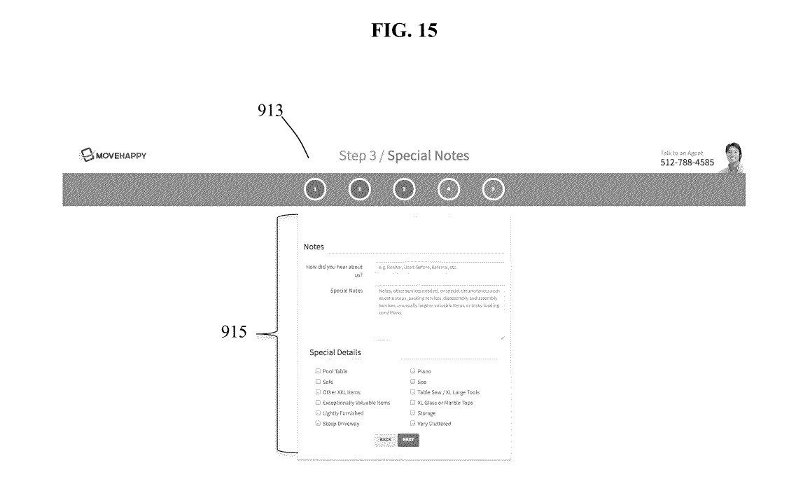

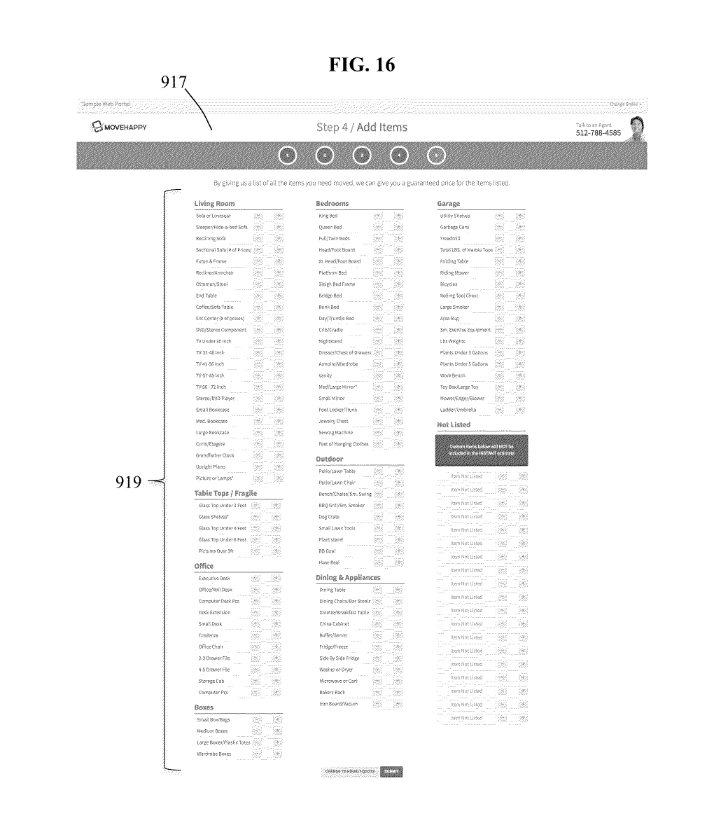

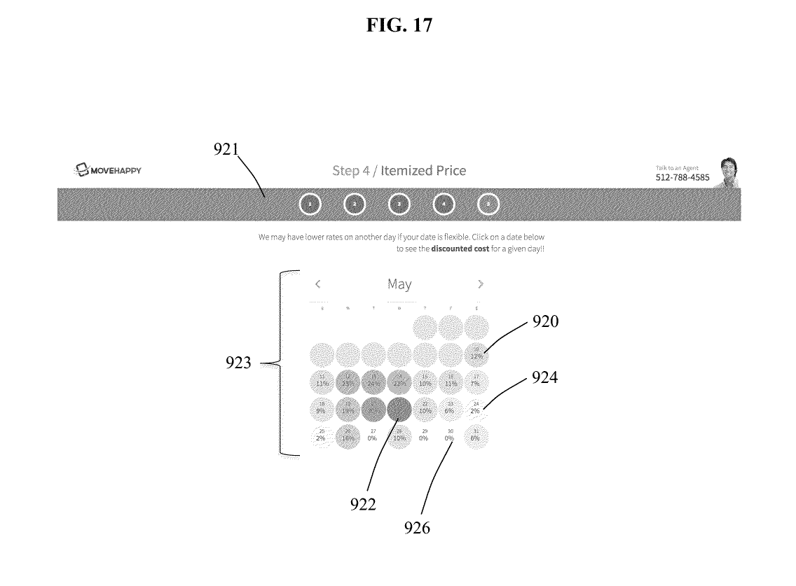

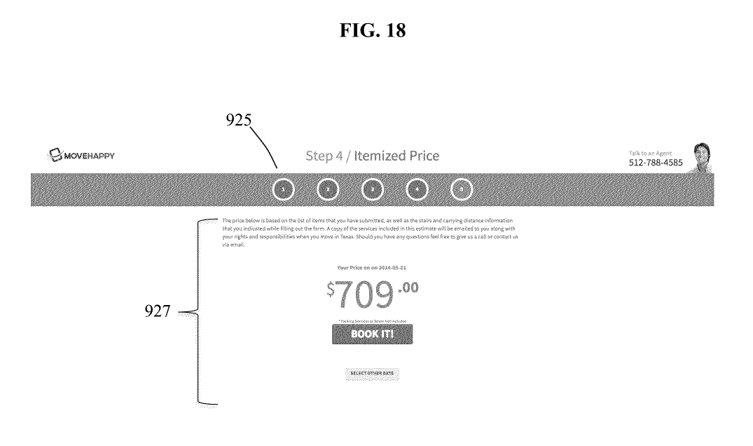

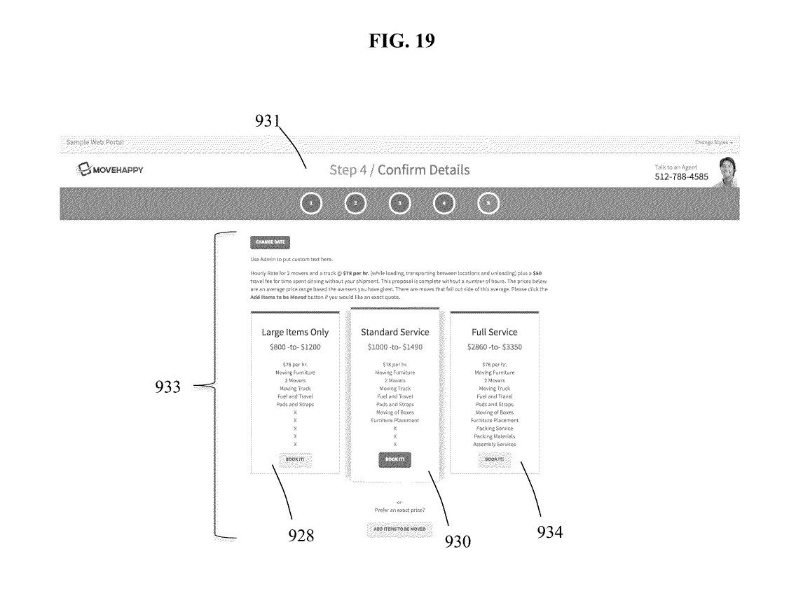

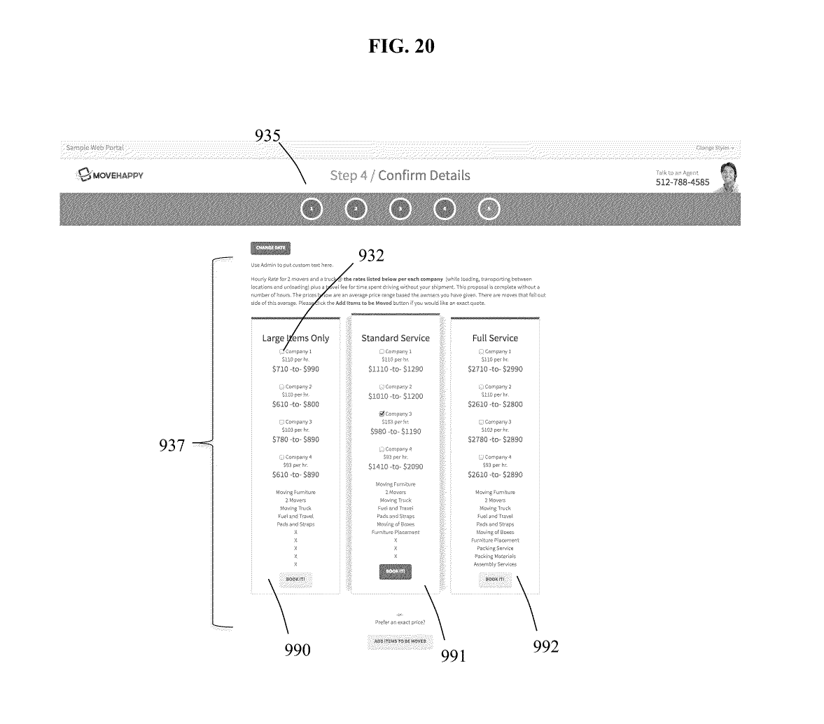

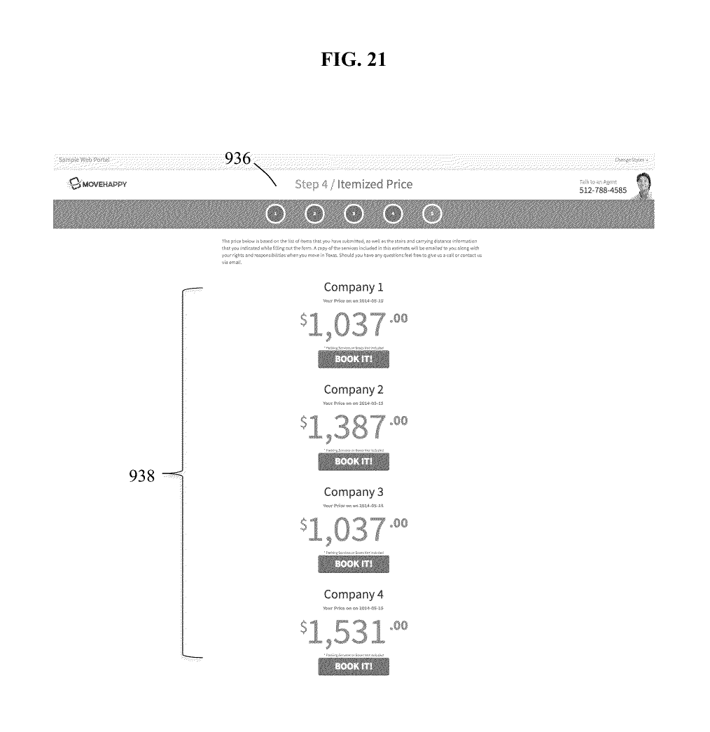

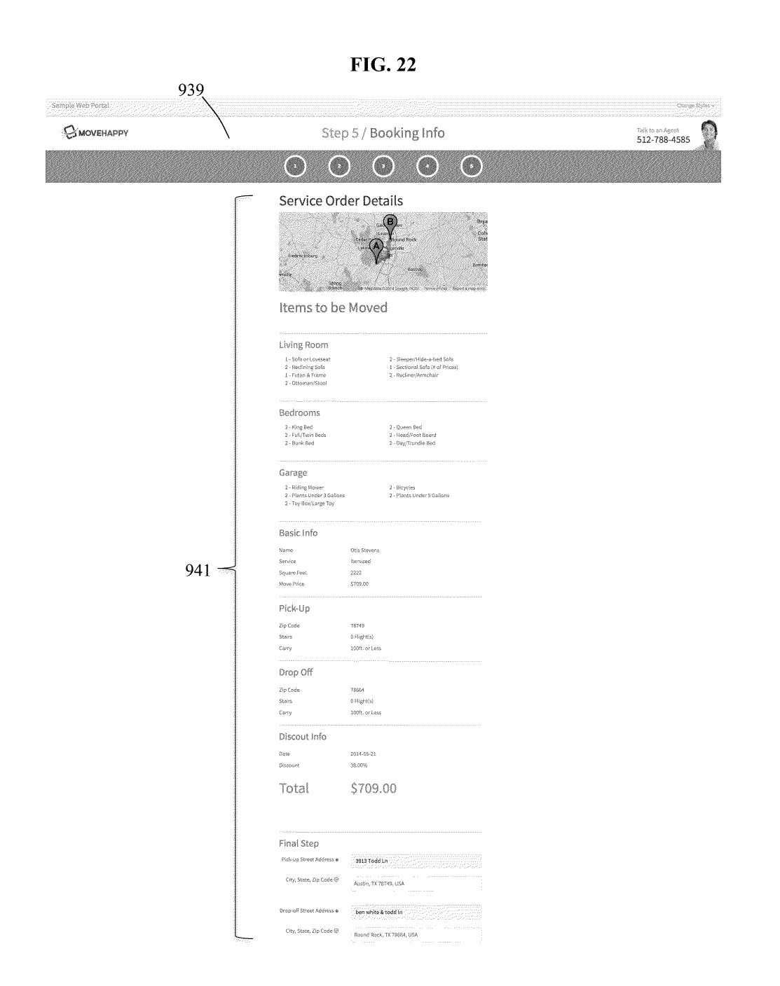

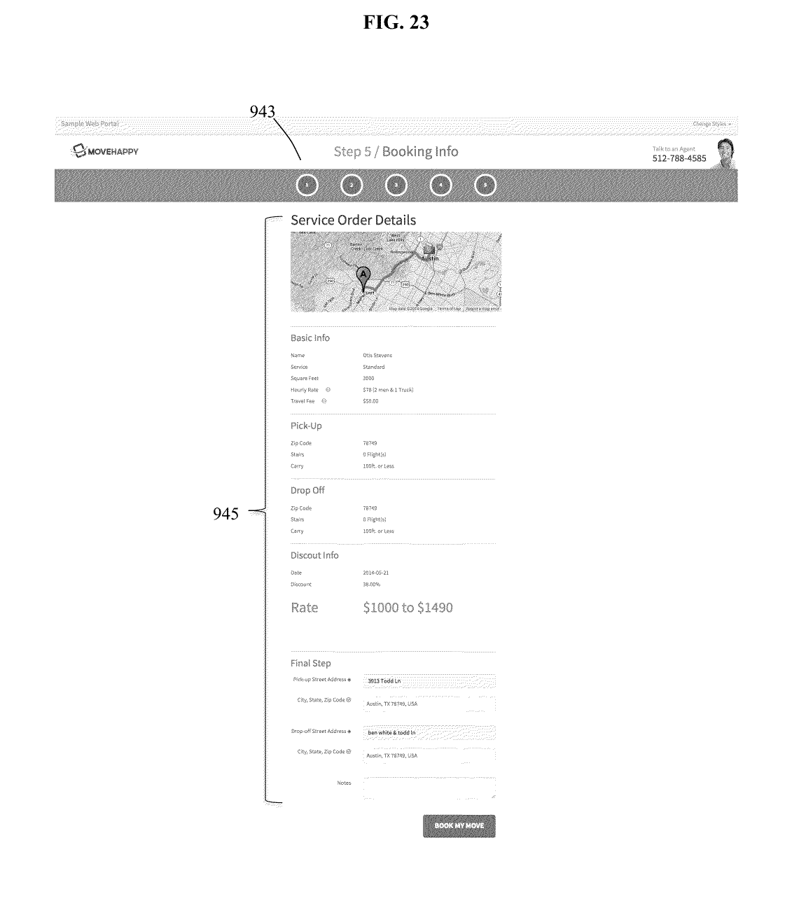

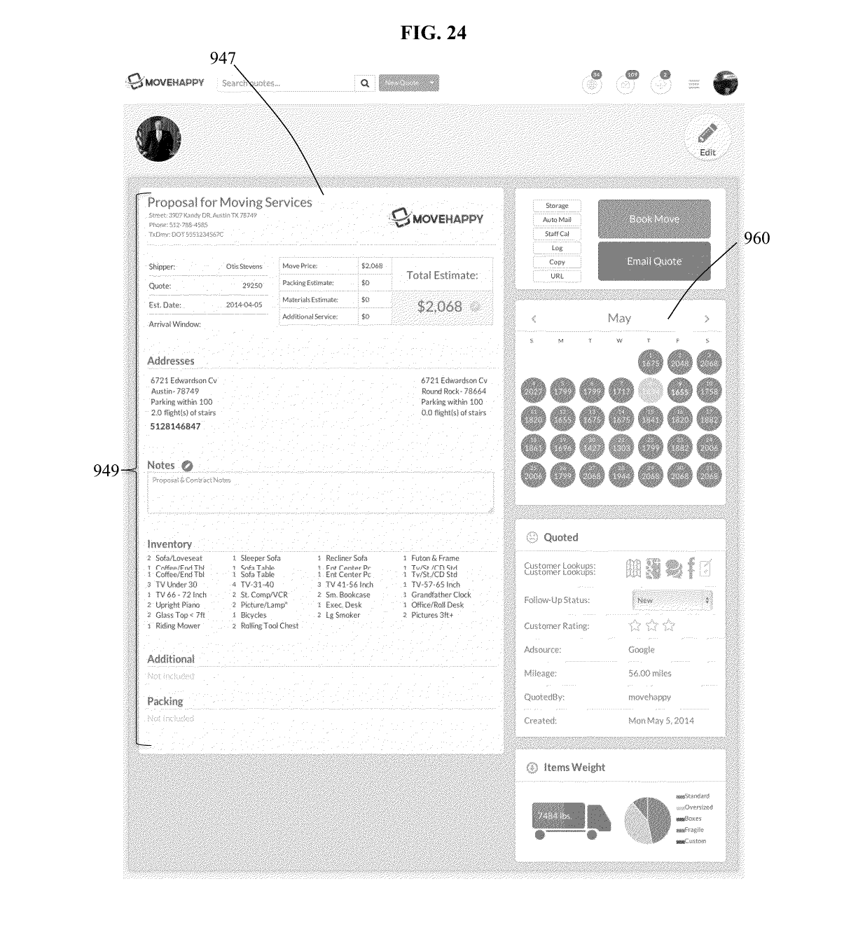

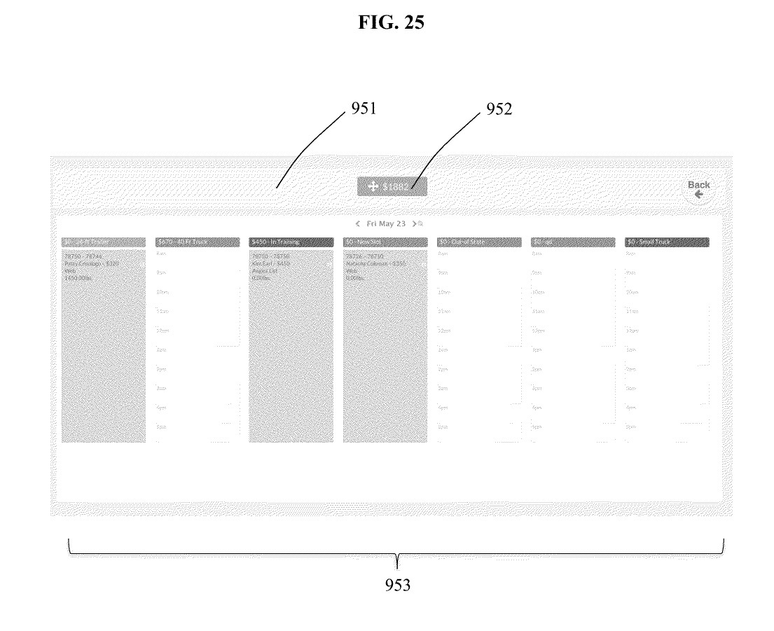

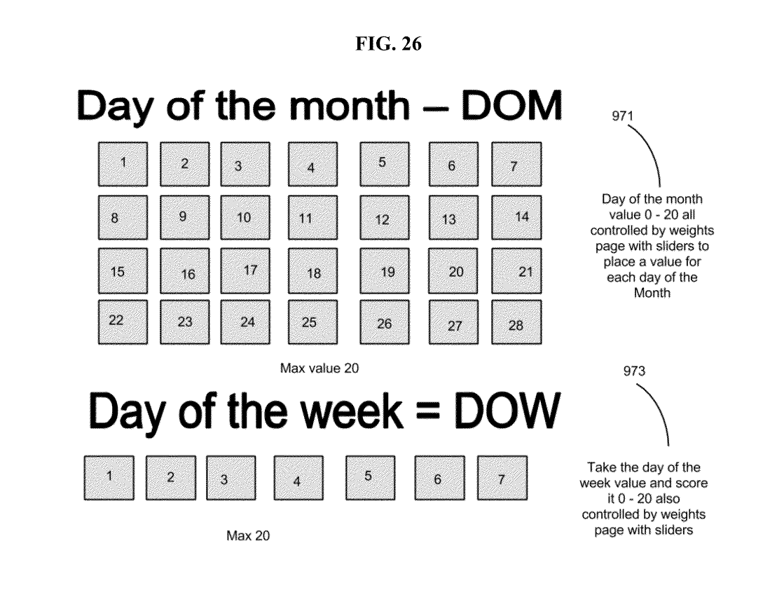

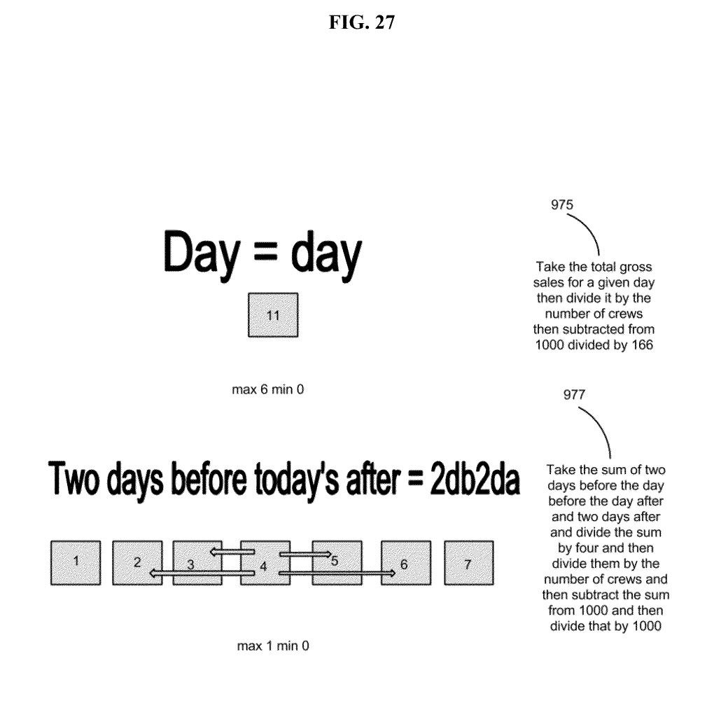

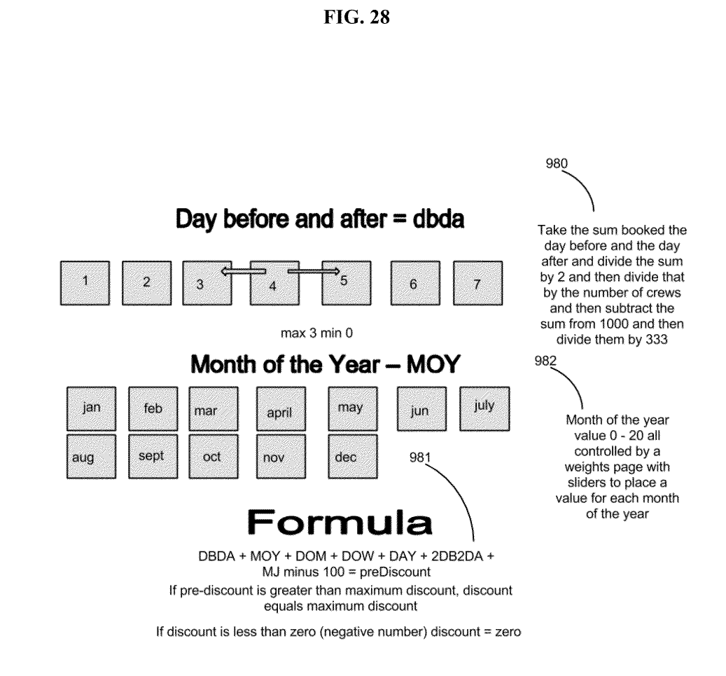

Referring now to the most preferred embodiment of the invention, in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27 and FIG. 28, the process flow and examples of screen views of the Qualitative Price Management Method invention are illustrated. FIG. 1 shows the Overview flowchart 100, which demonstrates an overview of the process flow of the method provided by the present invention. FIG. 2 illustrates the Discount_Weights_UI flowchart 200 that describes the process flow for applying discount weights using the method of the present invention. FIG. 3 depicts the Discount_Override_Adjust_UI flowchart 300 that explains the process flow for applying a discount override adjustment using the method of the present invention. FIG. 4 shows the Update_Discounts flowchart 400 that defines the process flow for updating discounts using the method of the present invention. FIG. 5 illustrates the Show_Discounts flowchart 500 that describes the process flow for showing discounts using the method of the present invention. FIG. 6 depicts the Webquote_UI flowchart 600 that explains the process flow for a providing an online quote using the method of the present invention. FIG. 7 shows the Marketplace_UI flowchart 700 that describes the process flow for providing a marketplace quote using the method of the present invention. FIG. 8 shows the dashboard user interface 800 of the software application of the present invention. FIG. 9 illustrates the discount weights user interface 814 of the software application of the present invention. FIG. 10 shows the day discount override user interface 836 of the software application of the present invention. FIG. 11 depicts the sales representative quote screen 856 of the software application of the present invention. FIG. 12 shows the web quote start screen 900 of the software application of the present invention. FIG. 13 illustrates the web quote basic information screen 905 of the software application of the present invention. FIG. 14 depicts the web quote location screen 909 of the software application of the present invention. FIG. 15 shows the web quote notes screen 913 of the software application of the present invention. FIG. 16 depicts the web quote add items screen 917 of the software application of the present invention. FIG. 17 illustrates the web quote calendar screen 921 of the software application of the present invention. FIG. 18 describes the web quote itemized price screen 925 of the software application of the present invention. FIG. 19 depicts the web quote confirmation screen 931 of the software application of the present invention. FIG. 20 portrays the marketplace quote confirmation page 935 of the marketplace aspect of the software application of the present invention. FIG. 21 illustrates the marketplace quote price screen 936 of the marketplace aspect of the software application of the present invention. FIG. 22 depicts the web quote itemized booking information screen 939 of the software application of the present invention. FIG. 23 describes the web quote hourly booking information screen 943 of the software application of the present invention. FIG. 24 portrays the web quote proposal screen 947 of the software application of the present invention. FIG. 25 shows crew-scheduling screen 951 of the software application of the present invention. FIG. 26 describes the day-of-the-month formula 971 and the day-of-the-week formula 973, which are both used by the pricing algorithm. FIG. 27 depicts the day-day formula 975 and the two-days-before-today's-after formula 977, which are both used by the pricing algorithm. FIG. 28 shows the day-before-and-day-after formula 980, which is used by the pricing algorithm.

In further detail, referring now to the invention of FIG. 1, FIG. 2, FIG. 3, FIG. 4, FIG. 5, FIG. 6 and FIG. 7, FIG. 1 shows the Overview flowchart 100, which demonstrates the initial process flow of the method provided by the present invention. The process flow of the present invention begins with the first step 101 of FIG. 1, when a user starts using the software application. In the user determination step 105, the type of user is determined. If the user is a web user, the web quote process flow step 115 described in the Webquote_UI flowchart 600 of FIG. 6 is followed. If the user is a marketplace user, the marketplace process flow step 110, described in the Marketplace_UI flowchart 700 of FIG. 7, is followed. The remainder of FIG. 1 describes the process flow for a staff user. Next, the staff user accesses the staff user login step 120 and logs into the staff user section of the software application. The staff user dashboard 125 is displayed within the software application. Next, in the determine staff user step 130, the type of staff user is determined. If the staff user is an administrator, the administrator enters the administrator section of the software application. To qualitatively adjust global discount weights, the administrator selects pricing plan navigation step 140 and is directed to the discount weights process flow step 143, thereby triggering the Discount_Weights_UI flowchart 200 of FIG. 2. In FIG. 2, the discount weights process is started in the discount weight start step 201. Next, in the select all weights step 205, all weight values that reside in the database are selected. Next, in the maximum discount slider display step 210, an adjustable slider, which represents the amount of the maximum discount, is labeled “maximum discount” and displayed with a minimum value of 0, which corresponds to a 0% maximum discount, and a maximum value of 50, which corresponds to a maximum global discount of 50%. Next, in the day-of-the-week slider display step 215, an adjustable slider is displayed for each day of the week, Sunday through Saturday, and respectively labeled, with each adjustable slider having a minimum value of 0 and a maximum value of 20. Next, in the month-of-the-year slider display step 220, an adjustable slider is displayed for each month of the year, January through December, and respectively labeled, with each adjustable slider having a minimum value of 0 and a maximum value of 20. Next, in the day-of-the-month slider display step 225, an adjustable slider is displayed for each day of a month, the 1^{st} through the 31^{st}, and respectively labeled, with each adjustable slider having a minimum value of 0 and a maximum value of 20. Next, in the loop values step 230, the weight values that were selected from the database in the select all weights step 205 are used to assign the appropriate values to each input field and set the various sliders to the values returned from the database. Next, to qualitatively adjust the global discount weights, a slider may be dragged in the drag global slider step 235. Dragging a slider is a qualitative adjustment because it allows an administrator to make an adjustment based on the administrator's intuition and instinct about patterns the administrator's business. If a slider is dragged, in the pass adjusted variables step 245, the current date is set as the start date and the current date plus six months is set as the end date, and these variables are passed to the update discounts script. Next, the weight value that was qualitatively adjusted with a slider is updated in the database in the update global weight value step 250. Next, the updated global weight value is passed to the update discount process flow step 170, thereby activating the Update_Discounts flowchart 400 of FIG. 4. In FIG. 4, the update discounts process begins in the start update discounts step 401. Next, start date and end date variables are created in the create update variables step 402. Next, weight variables are retrieved from the database in the retrieve weigh variables step 403. Next, the maximum discount variable is retrieved from the database in the retrieve maximum variable step 405. Next, in the retrieve total sales step 407, the total sales are retrieved from the database for each day between the start date and end date. Next, in the retrieve discount adjustments step 409, the discount adjustments for each day between the start date and end date are retrieved from the database. Next, in the retrieve total placeholders step 411, the total placeholder values for each day between the start date and end date are retrieved from the database. Next, in the retrieve crew count step 413, the available crew count is retrieved. Next, in the repeat each day step 415, a loop commences for each date between the start date and the end date. If the loop is active, sales data, the total number of placeholders, and the available crew on the current day being iterated and for four days surrounding the current date being iterated in the retrieve four-day data step 423. Next, in the apply scale formula step 421, a formula is applied to scale the value between a minimum value of 1 and a maximum value of 10. Next, in the create discount variable step 419, a variable for the discount is created and assigned the value determined by the algorithm. Next, in the retrieve current day-of-the-week step 435, the day of the week for the current day in the loop is determined. Next, in the retrieve day-of-the-week weight step 425, the weight value associated with the day of the week for the current day in the loop is retrieved from the database and added to the discount variable. Next, in the retrieve current day-of-the-month step 427, the day of the month for the current day in the loop is determined. Next, in the retrieve day-of-the-month weight step 429, the weight value associated with the day of the month for the current day in the loop is retrieved from the database and added to the discount variable. Next, in the retrieve current month-of-the-year step 431, the month of the year for the current day in the loop is determined. Next, in the retrieve month-of-the-year weight step 433, the weight value associated with the month of the year for the current day in the loop is retrieved from the database and added to the discount variable. Next, in the determine discount adjustment step 437, it is determined whether there is a discount adjustment for the current day in the loop. If there is a discount adjustment for the current day in the loop, the discount adjustment is added to the discount variable in the add discounts step 439. Next, in the discount comparison step 441, whether the total discount for the current day in the loop is greater than the maximum discount is determined. If the total discount for the current day in the loop is greater than the maximum discount, then the total discount for the current day in the loop is an excessive discount, as determined by the over discount step 443, and the total discount for the current day in the loop is set to the maximum discount in the set to maximum discount step 445. Next, a color is assigned to the total discount for the current day in the loop based on the size of the discount in the assign color step 447. Next, in the update database step 449, the database is updated with the current date in the loop, the total discount for the current day in the loop, the assigned color of the discount for the current day in the loop, and the total price. Next, in the determine marketplace update step 451, whether the user is a marketplace user is determined. If the user is a marketplace user, the zip code and company name is retrieved in the update marketplace information step 453, and the marketplace database is updated with the current date in the loop, the total discount for the current day in the loop, the assigned color of the discount for the current day in the loop, the total price, the zip code and the company name in the update marketplace database step 455. The process that begins in the repeat each day step 415 is repeated for each day between the start date and the end date. Once all of the discounts for each day in the loop are updated, the update discount exit step 417 of FIG. 4. returns the administrator to the update discount process flow step 170 of the Discount_Weights_UI flowchart 200 of FIG. 2. The process beginning at the drag global slider step 235 is repeated for each global discount weight slider that is adjusted. An administrator may choose to make adjustments to the global discount weights during the initial set up and then only make additional global adjustments rarely. Once all desired global discount weights are qualitatively adjusted, the discount weights end step 240 of FIG. 2 returns the administrator to the discount weights process flow step 143 of the Overview flowchart 100 of FIG. 1. To qualitatively adjust daily discounts, the administrator selects the day discounts step 145 and is directed to the discount override adjustment process flow step 147, thereby triggering the Discount_Override_Adjust_UI flowchart 300 of FIG. 3. In the Discount_Override_Adjust_UI flowchart 300 of FIG. 3, the discount override adjustment process begins in the override login step 301. Next, the administrator selects the navigation menu in the override navigation step 305 and clicks “day discounts” in the override day discounts step 310. Next, in the override calendar display step 315, a calendar is displayed with the current discounts, which were determined by the global discount weights, and the total booked for each day is display on each day of the calendar in the total booked override step 320. Next, the background of each day in the calendar is color-coded based on the size of the discount in the override color-coding step 325. Next, in the override slider display step 330, a slider is displayed below each discount for each day in the calendar and is set to the current discount value for that day. If a slider for a day in the calendar is dragged in the override slider step 335, the calendar display and the database are updated with the qualitatively adjusted discount values in the update override step 345. Next, the color-coding for the day with the qualitatively adjusted discount value is updated based on the new value in the update override color step 350. Next, in the pass override data step 355, the qualitatively adjusted discount value is passed to the update discount process flow step 170, thereby activating the Update_Discounts flowchart 400 of FIG. 4 and repeating the steps listed above for the Update_Discounts flowchart 400. After the discounts for each day in the loop of the Update_Discounts flowchart 400 are updated, the update discount exit step 417 of FIG. 4. returns the staff user to the update discount process flow step 170 of the Discount_Override_Adjust_UI flowchart 300 of FIG. 3. The process that begins with the override slider step 335 is repeated for each day in the calendar that has its discount qualitatively adjusted by dragging a slider. Once all of the desired daily override discounts are qualitatively adjusted in the displayed calendar, the daily discount end step 340 of FIG. 3 returns the administrator to the discount override adjustment process flow step 147 of the Overview flowchart 100 of FIG. 1. Next, the administrator decides whether to generate a quote in the administrator quote decision step 149. If the administrator chooses not to generate a quote, the next step is the administrator end step 148, and the administrator is done with the process until the next time the administrator chooses to qualitatively adjust the discount weights or the daily discount override. If the administrator wishes to make a quote or if the determine staff user step 130 of FIG. 1 determines that the staff user is a sales representative, the next step is the click new quote step 133, in which the staff user begins to generate a new quote for a moving service. Quotes may be generated on an itemized basis, which is determined by the items being moved, or on an hourly basis, which is determined by estimating the time involved for the move. Next, in the enter contact information step 135, the staff user enters contact information for a moving service customer. The contact information includes, but is not limited to, first name, last name, email address, telephone number, the zip code moving from, the zip code moving to, and the estimated date of the move. Next, in the enter quote details step 137, the staff user enters quote details for the moving services customer into the software application. The quote details include, but are not limited to, a description of the pick-up location; a description of the drop-off location; the type of location, such as whether the location is a house, apartment, condo, office or storage unit, or the like; the number of stairs involved at each location; the carrying distance at each location; whether any special details apply to the move, including any special items that need to moved, such as a pool table, a safe, other large items, exceptionally valuable items, a spa, a table saw, large glass tops, or like special items; whether special conditions exist at any of the locations, including whether there is a steep driveway, if the location is lightly furnished or very cluttered, or like special conditions; and the individual items being moved and how many of each; or other like information. Next, in the submit quote step 139, the staff user selects the submit quote option. Next, the software application uses a script to generate a base price for the moving service in the price generating script step 150. In the pass price step 151, the generated base prices are submitted by the software application to the show discounts process flow step 153, thereby prompting the Show_Discounts flowchart 500 of FIG. 5. In the Show_Discounts flowchart 500 of FIG. 5, the show discounts process flow begins in the start show discounts step 501. In the determine day set step 505, whether the day is set is determined. If the day is not set, the day is set to the current day in the set to current day step 510. If the day is set, a discount cache is retrieved for the month during which the set day occurs in the retrieve discount cache step 515. Next, whether a quote is for a web quote or marketplace quote is determined in the determine quote type step 520. If the quote is not a web quote or marketplace quote, the software application draws a calendar of the current month in the draw staff quote calendar step 525. Next, a variable for the total base price is established in the establish total base price step 530 and the value of the current moving service price is assigned to the total base price variable in the assign total variable step 535. Next, for each day in the displayed calendar the total base price is multiplied by the total discount in the determine displayed discount step 540. Next, a color is applied to the background of each day in the calendar based on the amount of the total discount in the apply calendar color step 545. After the color is applied to the background, the show discount end step 550 of FIG. 5 returns the staff user to the show discounts process flow step 153 of the Overview flowchart 100 of FIG. 1. If the quote is a web quote or marketplace quote, the software application displays a calendar of the month of the estimated service date in the display online quote calendar step 555. Next, whether the quote is a marketplace quote is determined in the determine marketplace quote step 560. If the quote is a marketplace quote, discounts are selected for each company near the pick-up zip code or the drop-off zip code in the select company step 570 and the largest of the company discounts are displayed for each day on the calendar in the display largest company discount step 575. If the quote is not a marketplace quote, discounts are displayed for each day on the calendar in the display web quote calendar step 565. Next, whether the quote is a marketplace quote or not, a color is applied to the background of each day in the calendar with a transparency based on the amount of the total discount in the apply calendar transparency step 580. After the color is applied to the background with the transparency based on the amount of the discount, the show online discount end step 585 of FIG. 5 returns the user to the show discounts process flow step 153 of the Overview flowchart 100 of FIG. 1. Returning to FIG. 1, next, in the select day step 155, the staff user selects the desired day of the move. Next, in the display daily calendar step 157, a daily calendar is displayed that shows the available slots to schedule the move for that day. Next, in the draggable square display step 160, a draggable square is displayed above the calendar slots. Next, in the display discount price square step 163, the discounted cost of the moving service is displayed within the draggable square. Next, in the make draggable step 165, the draggable square is made into a draggable element by the software application. Next, in the drag square step 167, the staff user drags the draggable square into the appropriate unoccupied slot in the daily calendar that corresponds to the time of the scheduled moving services. After the square is dragged into the appropriate slot, in the pass date step 169, the reserved date for the moving service is passed to the update discount process flow step 170, thereby activating the Update_Discounts flowchart 400 of FIG. 4 and repeating the steps listed above for the Update_Discounts flowchart 400. After the discounts for each day in the loop of the Update_Discounts flowchart 400 are updated, the update discount exit step 417 of FIG. 4. returns the staff user to the update discount process flow step 170 of the Overview flowchart 100 of FIG. 1. Next, in the insert record step 175, the discount value for the individual job is inserted into the record that resides in the database and the price is updated. After updating the database, the process is completed in the overview end step 177.

In further detail, referring now to FIG. 1, FIG. 2. FIG. 3, FIG. 5 and FIG. 6, the method of the present invention allows a moving company to use the system to establish an online presence and display dynamic discount pricing, which can be instantly updated, to a web user. A web user is a customer of a moving company who accesses the software application through a web browser and generates a quote for moving services using the online tool. If the user is a web user, the web quote process flow step 115 of FIG. 1 initiates the Webquote_UI flowchart 600 of FIG. 6. In the Webquote_UI flowchart 600 of FIG. 6, the first step is that the web user visits the website of a moving company using the present invention in the visit website step 601. Next, in the web user contact information step 605, the web user enters their contact information, including, but not limited to, the zip codes of the pick-up and drop-off locations, and the desired date of the move. Next, the web user enters the square feet of the locations, the number of stairs, the carrying distance, and other like information, in the web user location information step 610. Next, in the web user notes step 615, the web user enters the source of advertising through which they discovered the website and other relevant notes. Next, in the determine hourly step 620, the web user decides whether the web quote will be an hourly quote or an exact quote. An hourly quote is based on the estimated time involved for a move. An exact quote is based on the actual items being moved. If the quote is an hourly quote, the web user is presented with a checklist for large items and unusual factors, which may be experienced during the move, in the check hourly step 630. If the quote is an exact quote, the web user enters the items being moved and the quantities of each item in the enter exact items step 625. Whether the quote is hourly or exact, the quote information gathered is used to generate a base price for the move, and the generated base prices are submitted by the software application to the show discounts process flow step 153, thereby prompting the Show_Discounts flowchart 500 of FIG. 5, along with discount information, which was subject to qualitative adjustment by the administrator by using the discount override adjustment process flow step 147 and following the Discount_Override_Adjust_UI flowchart 300 of FIG. 3 or by using the discount weights process flow step 143 and following the Discount_Weights_UI flowchart 200 of FIG. 2 and which was stored in the web user database 645 through those processes. After the dates with available discounts are shown with color-coding, the show online discount end step 585 of FIG. 5 returns the user to the show discounts process flow step 153 of the Webquote_UI flowchart 600 of FIG. 6. Next, in the web user click date step 655, the web user selects the desired date for the move or the date with the most desirable discount available. Next in the show web user price step 660, the price with the discounted rate is shown for the selected day. Next, in the web user order detail step 665, the details of the order are shown to the web user for verification. Next, in the web user input step 670, an input field is displayed, and the web user enters the addresses for the move and selects the submit button. Next, in the web user submission determination step 675, if the web user selects the submit button, the information gathered for the web user's move is entered into the moving company's web user client database 645 in the insert web user company date step 680, and the process ends in the end web user quote step 685.

In further detail, referring now to FIG. 1, FIG. 2. FIG. 3, FIG. 5 and FIG. 7, the method of the present invention allows competing moving companies to use the system in an online marketplace, or clearinghouse, and allows the moving companies to display dynamic discount pricing, which can be instantly updated, to a marketplace user. A marketplace user is a potential customer for moving services who accesses the software application through a web browser and generates a series of quotes for a moving service from various competing moving companies using the online tool. If the user is a marketplace user, the marketplace quote process flow step 110 of FIG. 1 initiates the Marketplace_UI flowchart 700 of FIG. 7. In the Marketplace_UI flowchart 700 of FIG. 7, the first step is that the marketplace user visits the marketplace website, which uses the present invention, in the visit marketplace website step 701. Next, in the marketplace user contact information step 705, the marketplace user enters their contact information, including, but not limited to, the zip codes of the pick-up and drop-off locations, and the desired date of the move. Next, the marketplace user enters the square feet of the locations, the number of stairs, the carrying distance, and other like information, in the marketplace user location information step 710. Next, in the marketplace user notes step 715, the marketplace user enters the source of advertising through which they discovered the marketplace website and other relevant notes. Next, in the determine marketplace hourly step 720, the marketplace user decides whether the marketplace quote will be an hourly quote or an exact quote. An hourly quote is based on the estimated time involved for a move. An exact quote is based on the actual items being moved. If the marketplace quote is an hourly quote, the marketplace user is presented with a checklist for large items and unusual factors, which may be experienced during the move, in the check marketplace hourly step 730. If the marketplace quote is an exact quote, the marketplace user enters the items being moved and the quantities of each item in the enter marketplace exact items step 725. Whether the marketplace quote is hourly or exact, the marketplace quote information gathered is used to generate a base price for the move, and the generated base prices are submitted by the software application to the show discounts process flow step 153, thereby prompting the Show_Discounts flowchart 500 of FIG. 5, along with discount information for each participating moving company, which was subject to qualitative adjustment by each of the administrators of each of the competing moving companies by using the discount override adjustment process flow step 147 and following the Discount_Override_Adjust_UI flowchart 300 of FIG. 3 or by using the discount weights process flow step 143 and following the Discount_Weights_UI flowchart 200 of FIG. 2 and which was stored in the marketplace user database 745 through those processes. After the dates with available discounts from each of the competing moving companies are shown with color-coding, the show online discount end step 585 of FIG. 5 returns the user to the show discounts process flow step 153 of the Marketplace_UI flowchart 700 of FIG. 7. Next, in the marketplace user click date step 755, the marketplace user selects the desired date for the move or the date with the most desirable discount available. Next in the show marketplace user price step 760, the discounted prices from each of the participating moving companies are shown for the selected day. Next, in the marketplace user order detail step 765, the details of the order are shown to the marketplace user for verification. Next, in the marketplace user input step 770, an input field is displayed, and the marketplace user enters the addresses for the move and selects the submit button. Next, in the marketplace user submission determination step 775, if the marketplace user selects the submit button, the information gathered for the marketplace user's move is entered into the marketplace user client database 745 in the insert marketplace user company date step 780, and the process ends in the end marketplace user quote step 785.

In further detail, referring now to FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24 and FIG. 25, screen views of the software application of the present invention are shown. In FIG. 8, a screen view of the dashboard 800 of the software application is shown. The dashboard 800 is used by a staff user of the software application. A dashboard navigation menu 801 allows a user to navigate between various sections of the software application. A dashboard calendar 802 is displayed with color-coded discount rates 806, 808, 810 shown for each day. A colorless date 806 indicated that no discounts are available for that day. A mid-level colored date 808 indicates that a mid range discount rate is available for that day. An intense colored date 810 indicates that a large discount is available for that date. The color-coded dates help users identify which date offer better discounts. Dashboard calendar events 803 are displayed in the dashboard 800 to provide an overview of events to the user. Dashboard statistics 812 are also displayed to provide useful information for the user. An administrator may make qualitative adjustments to discount prices by accessing the dashboard settings button 804. In FIG. 9, the discount weights screen 814, which is accessible through the dashboard settings button 804 of FIG. 8, is shown. Within the discount weights screen 814 an administrator may make qualitative adjustments to global discounts factors 815, 818, 822, 830, including the maximum discount weight 815, the days-of-the-week discount weights 818, the months-of-the-year discount weights 822, and days-of-the-month discount weights 830. To make qualitative adjustments to global discounts factors 815, 818, 822, 830, an administrator drags a slider along a continuous range based on the administrator's knowledge, instincts and intuition concerning their business's historic performance. The maximum discount weight 815 is qualitatively adjusted by dragging the monthly discount slider 816 along a range of a 0 minimum discount and a 50 maximum discount. The days-of-the-week discount weights 818 are displayed within a daily slider array 820 with a slider for each day of the week, Sunday through Saturday. The days-of-the-week discount weights 818 are qualitatively adjusted by dragging a daily discount slider 826 for a day of the week along a range of a 0 minimum discount and a 20 maximum discount. The months-of-the-year discount weights 822 are displayed within a monthly slider array 828 with a slider for each month of the year, January though December. The month-of-the-year discount weights 822 are qualitatively adjusted by dragging a monthly discount slider 824 for a month of the year along a range of a 0 minimum discount and a 20 maximum discount. The day-of-the-month discount weights 830 are displayed within a day-of-the-month slider array 834 with a slider for each day of a month, the 1^{st} through the 31^{st}. The day-of-the-month discount weights 830 are qualitatively adjusted by dragging a day-of-the-month discount slider 832 for a day of a month along a range of a 0 minimum discount and a 20 maximum discount. After making adjustments to the global discounts factors 815, 818, 822, 830, the updated discounts are stored in the database. An administrator may choose to make adjustments to the global discount weights during the initial set up and then only make additional global adjustments rarely. In FIG. 10, the day discount override screen 836, which is accessible through the dashboard settings button 804 of FIG. 8, is shown. The day discount override screen 836 appears as a calendar that displays daily information 840, 838, 844, 846 for each day and displays a daily override slider 848 and a daily booked checkbox 850 for each day. For each day, the override date 840 is displayed to show the day of the month. For each day, the daily total booked 842 is displayed to show how much work is already booked for that particular day. For each day, the algorithm base discount 838 is displayed with the discount amount calculated by the algorithm based on any global discount factors 815, 818, 822, 830, that have been applied in the discount weights screen 814. For each day, the override adjust amount 844 is displayed, which reflects the amount of qualitative discount override adjustment that is being applied by the daily override slider 848. For each day, a daily booked checkbox 850 is displayed indicating whether the day is booked or not. For each day, the total override discount 846 is displayed in a color-coded circle with the total discount amount reflecting the sum of the algorithm base discount 838 and the override adjust amount 844. The color of the color-coding is determined by the amount of the total override discount 846 with red being the lowest discount (shown in the total override discount 846), yellow being for mid-range discounts (shown in the mid-level discount circle 854) and green being the largest discount (shown in the large discount circle 852). Other color-coding could be also be used based on the preferences of the user. Within the day discount override screen 836 an administrator may make qualitative adjustments to the discount offered on any particular day by dragging a daily override slider 848 for that day along a range of a 0% minimum discount and a 50% maximum discount. In FIG. 11, the quote information screen 856 is shown. The quote information screen 856 is intended to be used by a staff user to gather customer quote information 860, which critical information, including, but not limited to, the estimated move date 858, pick-up zip code 862, drop-off zip code 864, number of stairs 866, and walking distance 868. Labor and materials information 870 is also entered in the quote information screen 856, including room tabs 876 with selective lists of items 880 to be selected. For onsite estimates a minus button 878 and a plus button 882 are used to adjust the quantity of items. Quotes may be generated on an itemized basis by selecting the itemized quote button 872, and quotes may be generated on an hourly basis by selecting the hourly quote button 874. Information gathered in the quote information screen 856 is used to calculate a base price for moving services before applying any qualitative discounts. In FIG. 12, an online quote screen 900 is shown. The online quote screen 900 may be used for a web user quote or a marketplace user quote. For a web user quote, the company field 902 would reflect the name of the moving company using the present invention in their website. For a marketplace quote, the company field 902 would reflect the name of the online marketplace, in this case “Movehappy.” In the online quote screen 900, a user may select an hour quote using the online hourly quote button 901 or select an exact quote using the online exact quote button 903. In FIG. 13, the online basic information screen 905 is shown. The online basic information screen 905 is used to gather online contact information 907 from an online user. Online contact information 907 includes, but is not limited to, first name, last name, email address, telephone number, moving from zip code, moving to zip code, estimated date of the move, and other like information. In FIG. 14, the online location information screen 909 is shown. The online location information screen 909 is used to gather online location information 911 from an online user. The online location information 911 includes, but is not limited to, a description of the pick-up location; a description of the drop-off location; the square feet of the locations; the type of location, such as whether the location is a house, apartment, condo, office or storage unit, or the like; the number of stairs involved at each location; the carrying distance at each location. In FIG. 15, the online special notes screen 913 is shown. The online special notes screen 913 is used to gather special detail information 915 about the move from an online user. Special detail information 915 includes, but is not limited to, any special items that need to moved, such as a pool table, a safe, other large items, exceptionally valuable items, a spa, a table saw, large glass tops, or like special items; whether special conditions exist at any of the locations, including whether there is a steep driveway, if the location is lightly furnished or very cluttered, or like special conditions. In FIG. 16, the online add items screen 917 is shown. The online add items screen 917 is used to gather online itemized information 919, which includes, but is not limited to, itemized numbers of furniture and other physical items that the online user needs moved. In FIG. 17, the display online discounts screen 921 is shown. The display online discounts screen 921 shows the online user discount amounts that are available around the time of the desired move, so that the online user may select a date with the most advantageous discount, which also corresponds to the dates that the moving company has the most availability relative to the size of the offered discount. The display online discounts screen 921 shows an online discount calendar 923 with color-coded online discount circles 920, 922, 924, 926, for each day in the calendar. Large online discount color codes 922 are displayed with more intense coloring. Mid-range online discount color codes 920 are displayed with less intense coloring. Low-range online discount color codes 924 are displayed with light coloring. Days with no available discounts 926 are not colored. Other color-coding could be also be used based on the preferences of the administrator of the website. In FIG. 18, the online itemized price screen 925 is shown with online itemized price information 927. The online itemized price screen 925 is used to display an itemized quote to a web user. In FIG. 19, the online hourly price screen 931 is shown with online hourly price information 933. The online itemized price screen 925 is used to display an hourly quote to a web user. The hourly quote option breaks the offered prices into three tiers 928, 930, 934, with corresponding price ranges for each tier. The large item only tier 928 includes a range of hourly rates for the most limited of moving services in which only the largest items are moved. The standard service tier 930 includes a range of hourly rates for the moving services in which only items are moved. The full service tier 934 includes a range of hourly rates for full service moving services in which items are packed and moved. In FIG. 20, the online marketplace hourly price screen 935 is shown with online marketplace hourly price information 937. The online marketplace itemized price screen 935 is used to display hourly quotes to an online marketplace user. The hourly quote option breaks the offered prices into three marketplace tiers 990, 991, 992, with corresponding price ranges for each tier and differing offers from moving companies that are competing in the online marketplace and that used the present invention to make qualitative adjustments to any offered discounts. The large item only tier 990 includes a range of hourly rates for the most limited of moving services in which only the largest items are moved. The standard service tier 991 includes a range of hourly rates for the moving services in which only items are moved. The full service tier 992 includes a range of hourly rates for full service moving services in which items are packed and moved. An online marketplace user selects the preferred moving company within a given marketplace tier 990, 991, 992, by selecting the choose marketplace company checkbox 932. FIG. 21 shows the online marketplace price verification screen 936. The online marketplace price verification screen 936 displays online marketplace offers 938 for moving companies competing in the online marketplace that uses the present invention. In FIG. 22, the itemized online service order detail screen 939 is shown. The online itemized service order detail screen 939 summarizes the online itemized service order information 941 for the online user and allows the user to enter the addresses of the pick-up and drop-off locations. In FIG. 23, the online hourly service order detail screen 943 is shown. The online hourly service order detail screen 943 summarizes the online hourly service order information 945 for the online user and allows the user to enter the addresses of the pick-up and drop-off locations. In FIG. 24, the online proposal summary screen 947 is shown. The online proposal summary screen 947 displays proposal summary information 949 to a user. The proposal summary information 949 includes all of the information gathered for a moving service. A proposal summary calendar 960 is displayed to show discounts available for dates around the time of the proposed move so that the customer may optimize the price of the moving service. In FIG. 25, a crew booking screen 951 is shown. The crew booking screen 951 displays a daily booking calendar 953 for the day of the proposed move, along with a booking square 952, which displays the proposed price and which may be dragged into an available time slot within the daily booking calendar 953 in order to assign a crew to a moving service in that time slot.

In further detail, referring now to FIG. 26, FIG. 27 and FIG. 28, formulas used by the pricing algorithm of the software application of other embodiments the present invention are shown. In FIG. 26, the day-of-the-month formula 971 and the day-of-the-week formula 973 are shown. In the day-of-the-month formula 971 a day-of-the-month value is scaled from 0 to 20. In the day-of-the-week formula 973, the day-of-the-week value is scaled from 0 to 20, and each day-of-the-week's value is subject to qualitative adjustment by using a slider. In FIG. 27, the day-equals-day formula 975 and the two-days-before-two-days-after formula 977 are shown. In the day-equals-day formula 975, the total gross sales for a given day are divided by the number of crews and then subtracted from 1000 and divided by 166. In the two-days-before-two-days-after formula 977, the sum of the total gross sales of two days before the day, the day before the day, the day after the day and two days after the day are divided by four and then divided by the number of crews and subtracted from 1000 and then divided by 1000. In FIG. 28, the day-before-and-day-after formula 980 and the pre-discount formula 981 are shown. In the day-before-and-day-after formula 980, the sum of the gross sales from the day before the day and the day after the day are divided by two and then divided by the number of crews and then subtracted from 100 and divided by 333. In the month-of-the-year formula 982 a month-of-the-year value is scaled from 0 to 20 In the pre-discount formula 981, the pre-discount equals the day-before-and-day-after plus the day-of-the-month discount plus the day-of-the-week discount plus the day plus two-days-before-two-days-after plus the amount of manual adjustment minus 100.

The construction details of the most preferred embodiment of the present invention as shown in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27 and FIG. 28, are that the qualitative price management method for moving companies is a web-based software application that resides on a web server and is accessible by a computer through a web browser. The web-based software application interacts with a database that stores all gathered information. Information that is gathered for the use by an individual company is stored in a different database than information that is gathered for the use in the online marketplace. The color-coded interactive graphic user interface (GUI), which includes a calendar that displays discounts for each day and that displays sliders for the qualitatively adjusting daily discounts and which is generated by the disclosed method, is displayed on the monitors of users.

The advantages of the present invention include, without limitation, that it provides a method that allows moving companies to generated rules-based quotes for moving services using historic supply and demand data and allows moving companies to qualitatively adjust daily discount offers using sliders displayed in an easy to use color-coded monthly calendar format. The qualitative price management method of the most preferred embodiment of the present invention has the advantages of allowing onsite sales representatives to provide price estimates for moving services that are variable based on predetermined discounts calculated by a formula which includes a plurality of qualitative adjustments made by the owner/operator, or authorized user, of the moving company based on the owner/operator's knowledge, instinct and intuition; allowing sales representatives to provide price estimates for moving services over the phone that are variable based on predetermined discounts calculated by a formula which includes a plurality of qualitative adjustments made by the owner/operator, or authorized user, of the moving company based on the owner/operator's knowledge, instinct and intuition; providing moving companies with the ability to offer online price estimates for moving services that are variable based on predetermined discounts calculated by a formula which includes a plurality of qualitative adjustments made by the owner/operator, or authorized user, of the moving companies based on the owner/operator's knowledge, instinct and intuition; and allowing competing moving companies to provide price estimates for moving services in an online marketplace that are variable based on predetermined discounts calculated by a formula which includes a plurality of qualitative adjustments made by the owner/operator, or authorized user, of the moving companies based on the owner/operator's knowledge, instinct and intuition.

In broad embodiment, the present invention relates generally to a method of qualitative price management for businesses, which schedule services that use crews, the method comprising: providing a software application; gathering base pricing data for a requested service; displaying a matrix of qualitatively-adjustable global discount factors; qualitatively adjusting the global discount factors; using a pricing algorithm to determine a base daily discount rate for an individual day using the gathered base pricing data and the qualitatively-adjusted global discount factors; storing the calculated base daily discount rates in a database; displaying the calculated base daily discount rates in a monthly calendar format along with a qualitatively-adjustable discount override for each day; if further daily discount adjustment is desired, qualitatively-adjusting the total discount for a given day by using the qualitatively-adjustable discount override in the displayed monthly calendar; and color-coding the total daily discount depending on the size of the discount.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods that are within the scope and spirit of the invention as claimed.

What is claimed is:

1. A method of qualitative price management for businesses, said method comprising: providing a software application; gathering base pricing data for a requested service in said software application; displaying a matrix of qualitatively-adjustable global discount weights in said software application; using said software application to qualitatively adjust said qualitatively-adjustable global discount weights; using a pricing algorithm in said software application to calculate base daily discount rates for each day in a calendar using said gathered base pricing data and said qualitatively-adjusted global discount weights; storing said calculated base daily discount rates in a database that interacts with said software application; displaying said calculated base daily discount rates in a graphic user interface in said software application along with a qualitatively-adjustable discount override for said each day; and, if further daily discount adjustment is desired, qualitatively-adjusting the total discount for a given day by using said qualitatively-adjustable discount override in said displayed graphic user interface in said software application.

2. The method according to claim 1, wherein said graphic user interface further comprises a calendar.

3. The method according to claim 1, wherein said graphic user interface further comprises a monthly calendar.

4. The method according to claim 1, further comprising color-coding said total daily discount for said each day in said displayed graphic user interface of said software application depending on the size of said total daily discount for said each day.

5. The method according to claim 1, wherein said software application further comprises a web application that resides on a web server and is accessible by a computer through a web browser.

6. The method according to claim 1, wherein said business schedules services that use crews.

7. The method according to claim 1, wherein said business further comprises a moving company.

8. The method according to claim 1, wherein said qualitatively-adjustable global discount weights may be qualitatively adjusted by using sliders displayed in said software application.

9. The method according to claim 1, wherein said qualitatively-adjustable discount override may be qualitatively adjusted by using sliders displayed in said graphic user interface of said software application.

10. The method according to claim 1, wherein said qualitatively-adjustable global discount weights may be qualitatively adjusted by using a matrix of sliders displayed in said software application.

11. The method according to claim 1, wherein said qualitatively-adjustable discount override may be qualitatively adjusted by using a matrix sliders displayed in said graphic user interface of said software application.

12. The method according to claim 1, wherein said qualitatively-adjustable global discount weights further comprises: a maximum discount weight, a day-of-the-week discount weight, a month-of-the-year discount weight, and a day-of-the-month discount weight.

13. The method according to claim 1, further comprising color-coding said total daily discount for said each day in said displayed graphic user interface of said software application depending on the size of said total daily discount for said each day, wherein said color-coding further comprises red, yellow, or green, depending on the size of said total discount, with red being the low-level discounts, yellow being the mid-level discounts and green being the largest discounts.

14. The method according to claim 1, wherein said software application further comprises an online marketplace in which a plurality of competing companies may display said qualitatively-adjusted total discounts for each said competing business.

15. The method according to claim 1, wherein said base pricing data is determined on an hourly basis.

16. The method according to claim 1, wherein said base pricing data is determined on an itemized basis.

17. The method according to claim 1, wherein said base price data further comprises: months of the year, days of the week, days of the month, gross sales for any given day, gross sales for a given day plus the day before and the day after, and gross sales for a given day plus two days before and two days after, items to be moved, distance of the move, pick-up location, drop-off location and numbers of stairs.

18. The method according to claim 1, wherein said graphic user interface displays the total bookings for said each day, said base daily discount rates for each said day as calculated by said pricing algorithm, the amount of said total discount for each said day, whether said each day is booked or not, and a slider for qualitatively adjusting the discount for said each day.

19. A method of price management for moving companies, which allows for qualitative adjustment of pricing, said method comprising: providing a graphical user interface displayed on a computer display, said graphic user interface comprising an information accepting field and name for each day of the month, an information accepting field and name for each month of the year, and an information accepting field and name for each day of the week, whereby each said information accepting field is operable to accept a numeric value; in response to user changes to said numeric values of said information accepting fields, storing in a memory device the associated said name and entered said numeric value as a name-value pair; and making available said name-value pairs for calculating date specific discounts based on the sum of said numeric values associated with a given day's day of the month, month of the year, and day of the week.

20. The method of claim 19 wherein said numeric values are controlled by a slider.

21. The method of claim 19 further comprising said date specific discounts being applied to an itemized quote for moving services and materials.

22. The method of claim 19 further comprising said date specific discounts being applied to an hourly rate for moving services.

23. The method of claim 19 further comprising said date specific discounts being used to supply competitive pricing in a marketplace website wherein discounted pricing is displayed for multiple moving companies.

24. The method of claim 19 wherein said memory device is a client browser.

25. The method of claim 19 wherein said memory device is a web server.

26. The method of claim 19 further comprising date specific pricing being determined by a qualitative value scaled by the daily sales volume of said moving company.

27. The method of claim 19 further comprising: providing an overriding information accepting field and overriding name for each day of the next six months, wherein each said overriding information accepting field is operable to accept a numeric value; in response to manual changes by said user to said numeric value of said overriding information accepting field, assigning a manual discount to an individual day and storing said manual discount in said memory device; whereby said manual discount is added to said date specific discount to reduce or increase the total discount for that day.
